(19) United States
(12) Patent Application Publication
(10) Pub. No.: US 2026/0016939 A1
(43) Pub. Date: Jan. 15, 2026

(54) ELECTRONIC APPARATUS AND METHOD FOR PROVIDING IMAGE

(71) Applicant: SAMSUNG ELECTRONICS CO., LTD., Suwon-si (KR)

(72) Inventors: Joonhwan JEON, Suwon-si (KR); Seunghwan CHOI, Suwon-si (KR); Byeongseop KIM, Suwon-si (KR); Sangheon KIM, Suwon-si (KR); Jeongseob KIM, Suwon-si (KR); Jaewoo SUH, Suwon-si (KR); Hoyoung JANG, Suwon-si (KR); Dami JEON, Suwon-si (KR)

(73) Assignee: SAMSUNG ELECTRONICS CO., LTD., Suwon-si (KR)

(21) Appl. No.: 19/215,606

(22) Filed: May 22, 2025

Related U.S. Application Data
(63) Continuation of application No. PCT/KR2025/005357, filed on Apr. 21, 2025.

(30) Foreign Application Priority Data
Jul. 9, 2024 (KR) 10-2024-0090783
Aug. 30, 2024 (KR) 10-2024-0117848

(51) Int. Cl. G06F 3/04845; G06T 11/60

(52) U.S. Cl. CPC G06F 3/04845; G06T 11/60; G06T 2200/24; G06T 2210/62

(57) ABSTRACT

An electronic device includes a touch screen display, one or more processors including processing circuitry, and memory storing instructions. The instructions, when executed by the one or more processors individually or collectively, cause the electronic device to receive, via the touch screen display, a drawing based on a first user input, receive, via the touch screen display, a second user input for generating an image, acquire description information of the drawing, based on the second user input, determine a similarity between the drawing and the image to be generated, acquire the image to be generated based on at least a portion of the description information and the similarity, and display, via the touch screen display, the image.

### CROSS-REFERENCE TO RELATED APPLICATIONS

This application is a continuation application of International Application No. PCT/KR2025/005357, filed on Apr. 21, 2025, which claims priority to Korean Patent Application No. 10-2024-0090783, filed on Jul. 9, 2024, and Korean Patent Application No. 10-2024-0117848, filed on Aug. 30, 2024, in the Korean Intellectual Property Office, the disclosures of which are incorporated by reference herein in their entireties.

### BACKGROUND

### 1. Field

The present disclosure relates generally to electronic devices, and more particularly, to an electronic device and a method for providing an image.

### 2. Description of Related Art

Electronic devices may be provided with relatively complex functions such as, but not limited to, creating and/or capturing photos and/or videos, replaying music files and/or video files, gaming, receiving broadcasts, supporting wireless Internet, or the like, and may be implemented in the form of a multimedia device. Accordingly, electronic devices may be developed in new forms in terms of hardware and/or software to potentially enhance portability and/or convenience while addressing processing and/or functionality needs of the users.

In addition, with the development of artificial intelligence (AI) technologies and the emergence of generative AI models, various attempts may have been made to provide services based on new content extended from input data without being limited to the users' input data.

The above-described information is provided as a related-art technology for assisting in understanding the present disclosure. Any of the above-described content is not asserted as a prior art related to the present disclosure and is not to be used to determine a prior art related to the present disclosure.

### SUMMARY

According to an aspect of the present disclosure, an electronic device includes a touch screen display, one or more processors including processing circuitry, and memory storing instructions. The instructions, when executed by the one or more processors individually or collectively, cause the electronic device to receive, via the touch screen display, a drawing based on a first user input, receive, via the touch screen display, a second user input for generating an image, acquire description information of the drawing, based on the second user input, determine a similarity between the drawing and the image to be generated, cause a new image to be generated based on at least a portion of the description information and the similarity, and display, via the touch screen display, the new image.

According to an aspect of the present disclosure, a method of providing an image by an electronic device includes receiving, via a user interface displayed on a touch screen display of the electronic device, a drawing based on a first user input, receiving, via the user interface, a second user input for generating the image, acquiring description information of the drawing, based on the second user input, determining a similarity between the drawing and the image to be generated, causing a new image to be generated based on at least a portion of the description information and the similarity, and displaying, via the touch screen display, the new image.

According to an aspect of the present disclosure, a non-transitory computer readable storage medium stores a computer-executable program for providing an image that, when executed by at least one processor of an electronic device, cause the electronic device to receive, via a user interface displayed on a touch screen display of the electronic device, a drawing based on a first user input, receive, via the user interface, a second user input for generating the image, acquire description information of the drawing, based on the second user input, determine a similarity between the drawing and the image to be generated, cause a new image to be generated based on at least a portion of the description information and the similarity, and display, via the touch screen display, the new image.

Additional aspects may be set forth in part in the description which follows and, in part, may be apparent from the description, and/or may be learned by practice of the presented embodiments.

### BRIEF DESCRIPTION OF THE DRAWINGS

The above and other aspects, features, and advantages of certain embodiments of the present disclosure may be more apparent from the following description taken in conjunction with the accompanying drawings, in which:

FIG. 1 is a block diagram of an electronic device in a network environment, according to various embodiments;

FIG. 2 is a block diagram of an electronic device, according to an embodiment;

FIG. 3 is a view illustrating a plurality of artificial intelligence (AI) models interlocking with an electronic device, according to an embodiment;

FIG. 4 is a flowchart illustrating an image providing method of an electronic device, according to an embodiment;

FIG. 5 is a view illustrating examples of user interfaces to explain an image providing function of an electronic device, according to an embodiment;

FIG. 6 is a flowchart illustrating a method for providing an image by using a plurality of AI models in an electronic device, according to an embodiment;

FIGS. 7A, 7B, and 7C are views illustrating examples of user interfaces to explain a process of determining a style in an electronic device, according to an embodiment;

FIG. 8 is a flowchart illustrating a process of generating a first input prompt in an electronic device, according to an embodiment;

FIG. 9 is a flowchart illustrating a process of generating a first input prompt based on a style in an electronic device, according to an embodiment;

FIG. 10A is a view illustrating an example of a first input prompt that requests a simple description on a drawing, according to an embodiment;

FIG. 10B is a view illustrating an example of a first input prompt that requests a detailed description on a drawing, according to an embodiment;

FIG. 10C is a view illustrating an example of a first input prompt that requests both a simple description and a detailed description on a drawing according to an embodiment;

FIG. 11 is a view illustrating an example of a response to a first input prompt, according to an embodiment;

FIG. 12 is a flowchart illustrating a process of generating a first input prompt based on a skill level in an electronic device, according to an embodiment;

FIG. 13 is a view illustrating an example of a third input prompt that requests determination of a skill level, according to an embodiment;

FIG. 14 is a flowchart illustrating a process of generating a second input prompt based on a style in an electronic device, according to an embodiment;

FIGS. 15A, 15B, and 15C are views illustrating examples of a second input prompt that requests generation of an image, according to an embodiment;

FIG. 16 is a flowchart illustrating a process of generating a second input prompt based on a similarity by style in an electronic device, according to an embodiment;

FIG. 17 is a view illustrating an example of description information on a drawing, according to an embodiment;

FIGS. 18A and 18B are views illustrating examples of images that are acquired based on a similarity by style, according to an embodiment;

FIG. 19 is a flowchart illustrating a process of generating a second input prompt based on a similarity by skill level in an electronic device, according to an embodiment;

FIG. 20 is a view illustrating examples of user interfaces to explain a process of determining a similarity in an electronic device, according to an embodiment;

FIGS. 21A, 21B, 21C, and 21D are views illustrating examples of user interfaces to explain a process of displaying an image in an electronic device, according to an embodiment;

FIG. 22A is a view illustrating an example of a first input prompt that requests a description on a drawing, according to an embodiment;

FIG. 22B is a view illustrating an example of a second input prompt that requests generation of an image, according to an embodiment;

FIG. 23A is a view illustrating an example of a hardware configuration of an electronic device, according to an embodiment;

FIG. 23B is a block diagram of an electronic pen that is an input means, according to an embodiment;

FIG. 24 is a view illustrating an example of a hardware configuration of a foldable electronic device, according to an embodiment;

FIGS. 25A and 25B are views illustrating examples of a drawing and an image that are displayed on an electronic device, according to an embodiment;

FIG. 26 is a view illustrating an external electronic device that interlocks with an electronic device, according to an embodiment;

FIG. 27 is a flowchart illustrating an image providing method of an electronic device, according to an embodiment;

FIG. 28 is a view illustrating example of user interfaces to explain a process of receiving a drawing via an electronic pen in an electronic device, according to an embodiment;

FIG. 29 is a view illustrating examples of user interfaces to explain a process of receiving a drawing via an edge area in an electronic device, according to an embodiment;

FIG. 30 is a view illustrating examples of user interfaces to explain a process of receiving a drawing via a predefined application in an electronic device, according to an embodiment;

FIG. 31 is a view illustrating examples of user interfaces to explain an image providing function of an electronic device, according to an embodiment;

FIG. 32 is a view illustrating examples of user interfaces to explain a process of determining a style in an electronic device, according to an embodiment;

FIG. 33 is a view illustrating examples of user interfaces to explain a process of determining a similarity based on transparency in an electronic device, according to an embodiment; and

FIG. 34 is a view illustrating a system including a generative AI model, according to an embodiment.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art may recognize that various changes and modifications of the embodiments described herein may be made without departing from the scope and spirit of the present disclosure. In addition, descriptions of well-known functions and structures are omitted for clarity and conciseness.

With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

It is to be understood that when an element or layer is referred to as being “over,” “above,” “on,” “below,” “under,” “beneath,” “connected to” or “coupled to” another element or layer, it may be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

The terms “upper,” “middle”, “lower”, and the like may be replaced with terms, such as “first,” “second,” third” to be used to describe relative positions of elements. The terms “first,” “second,” third” may be used to describe various elements but the elements are not limited by the terms and a “first element” may be referred to as a “second element”. Alternatively or additionally, the terms “first”, “second”, “third”, and the like may be used to distinguish components from each other and do not limit the present disclosure. For example, the terms “first”, “second”, “third”, and the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout the present disclosure may, but do not necessarily, all refer to the same embodiment. The embodiments described herein are example embodiments, and thus, the present disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various embodiments of the present disclosure are described with reference to the accompanying drawings.

An electronic device may provide a drawing function. A user may draw a picture by using a drawing function on a display surface of the electronic device similarly to drawing on a physical paper. The electronic device may detect a user's input using an input tool (e.g., an electronic pen, a finger), and may process and/or display corresponding data.

The electronic device may provide a content (e.g., a text, an image or other media) corresponding to a prompt to the user by using a generative artificial intelligence (AI) model.

When an image is to be generated by using a text prompt, it may be difficult for normal users to describe a desired result with a text or to implement an appropriate prompt structure. Alternatively or additionally, there may be an inconvenience in that the user may need to acquaint themselves with complex parameters that may need to be included in the prompt. Thereby, the user may receive a result that may be different from what the user intended, and hence, user satisfaction may be degraded.

Various embodiments of the present disclosure may provide an electronic device and a method for providing an image, which support a user to represent a desired direction through a simple drawing without having to get acquainted with a complex prompt structure or to provide a cumbersome text input.

Various embodiments of the present disclosure may provide an electronic device and a method for providing an image, which may improve user convenience while implementing an image reflecting the user's intent, when compared to a related electronic device.

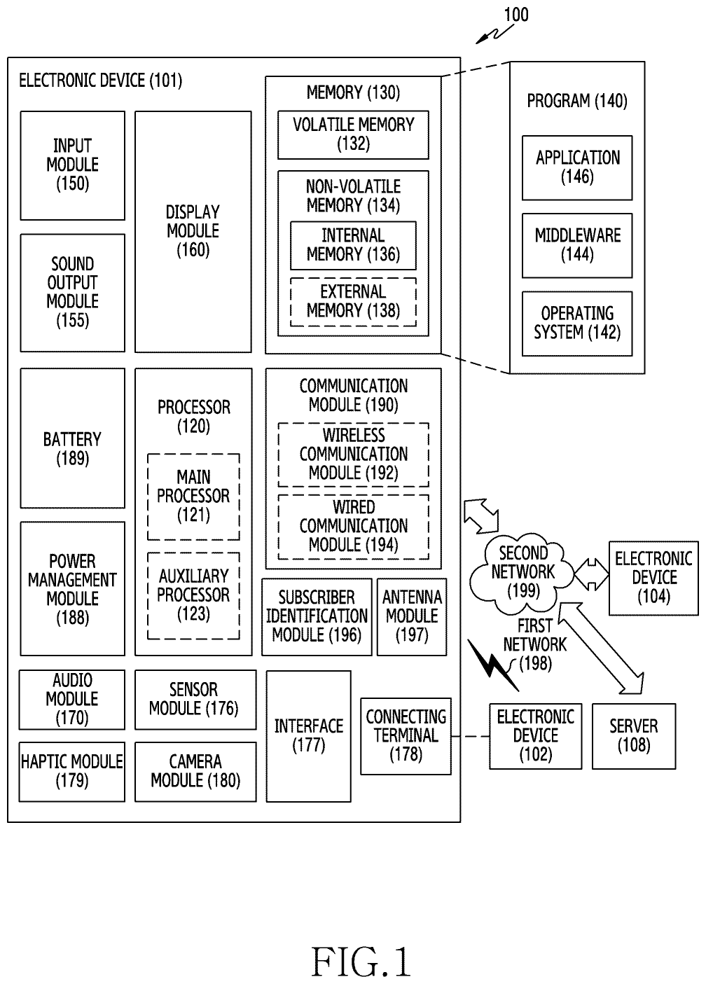

FIG. 1 is a block diagram illustrating an electronic device 101 in a network environment 100, according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that may be operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) from among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed where the artificial intelligence is performed (e.g., by the electronic device 101) or via a separate server (e.g., the server 108). Learning algorithms may include, but are not limited to, supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two (2) or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and/or convert an electrical signal to a sound. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus that may be recognized by a user via his tactile sensation or kinesthetic sensation. According to an embodiment, the haptic module 179 may include, for example, a motor, a piezoelectric element, or an electric stimulator.

The camera module 180 may capture still images and/or moving images. According to an embodiment, the camera module 180 may include one or more lenses, image sensors, image signal processors, and/or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell that is not rechargeable, a secondary cell that is rechargeable, and/or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology (e.g., new radio (NR) access technology). The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve a high data transmission rate. The wireless communication module 192 may support various technologies for securing performance on a high-frequency band, such as, but not limited to, beamforming, massive multiple-input and multiple-output (massive MIMO), full dimensional MIMO (FD-MIMO), array antenna, analog beam-forming, or large scale antenna. The wireless communication module 192 may support various design constraints specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 dB or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to and/or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal and/or the power may be transmitted and/or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, for example, distributed computing or mobile edge computing. In another embodiment, the external electronic device 104 may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

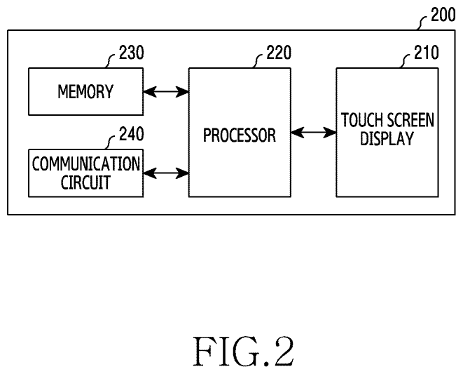

FIG. 2 is a block diagram of an electronic device 200, according to an embodiment.

Referring to FIG. 2, the electronic device 200 may include a touch screen display 210, a processor 220, and memory 230. The electronic device 200 may further include a communication circuit 240.

The electronic device 200 of FIG. 2 may correspond (e.g., may include and/or may be similar in many respects but may include additional features) to the electronic device 101 shown in FIG. 1. The touch screen display 210, the processor 220, the memory 230, and the communication circuit 240 included in the electronic device 200 of FIG. 2 may correspond to the display module 160, the processor 120, the memory 130, and the communication module 190 of FIG. 1, respectively.

The electronic device 200 may include an additional component in addition to the components shown in FIG. 2. At least one of the components shown in FIG. 2 may be omitted. In an embodiment, some of the components shown in FIG. 2 may be integrated into one component or one component may be separated into two (2) or more components.

The touch screen display 210, the processor 220, the memory 230, and the communication circuit 240 included in the electronic device 200 may be electrically and/or operatively connected with one another to exchange signals (e.g., commands or data) with one another.

According to an embodiment, the electronic device 200 (e.g., the electronic device 101 of FIG. 1) may perform an image providing function. For example, the electronic device 200 may perform the image providing function by using at least one generative artificial intelligence (AI) model. For example, the electronic device 200 may execute an application (e.g., a drawing application, a note application) and may perform the image providing function by using the application. The application executed in the electronic device 200 may operate independently or may operate in association with an external electronic device (e.g., the electronic device 102, the electronic device 104 of FIG. 1, or the server 108 of FIG. 1).

According to an embodiment, the touch screen display 210 may include a touch panel to provide a touch function and a display panel to provide a display function. The touch screen display 210 may have various layered structures. For example, the touch panel and the display panel may be independently configured, and may be packaged into one component. The touch panel may be implemented in an in-cell type to be integrated with a pixel layer of the display panel.

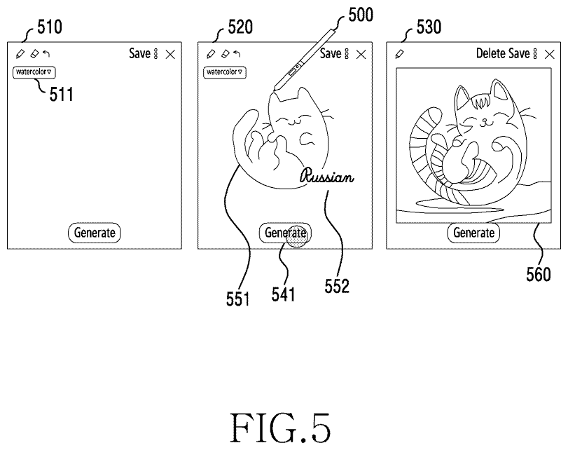

In an embodiment, the touch panel may include a plurality of layers. For example, the touch panel may include a first touch detection layer to detect a touch input using user's hand (e.g., finger, nail, or the like) and a second touch detection layer to detect a touch input using an electronic pen (e.g., an electronic pen 500 of FIG. 5).

However, the touch detection method and/or the layer structure of the touch panel are not limited in this regard and may be changed in various methods. For example, a touch input may be detected through one touch detection layer regardless of a type of an input tool (e.g., an electronic pen, a finger). As another example, the touch panel may include the first touch detection layer and the second touch detection layer, and the layers may be alternately enabled according to situations. In such a case, the second touch detection layer may be enabled in response to an electronic pen mode being turned on or accessed by the electronic pen being detected.

According to an embodiment, the touch panel may include one or more touch sensors that may be set to detect a touch. According to various embodiments, the touch sensor may detect a touch in at least one method of a contact type capacitance method, a pressure-type resistive method, an infrared ray detection method, a surface ultrasonic conduction method, and/or a piezo effect method. However, the touch detection method is not limited thereto.

According to an embodiment, the communication circuit 240 may support short-range wireless communication connection of the electronic device 200. For example, the communication circuit 240 may support short-range wireless communication (e.g., Bluetooth™, Bluetooth™ low energy (BLE), near field communication (NFC), Wi-Fi direct or infrared data association (IrDA)) connection between the electronic device 200 and an electronic pen (e.g., the electronic pen 500 of FIG. 5).

According to an embodiment, the communication circuit 240 may support long-range wireless communication connection of the electronic device 200. For example, the communication circuit 240 may support long-range wireless communication (e.g., cellular communication, network communication such as Internet) between the electronic device 200 and an external server (e.g., the server 108 of FIG. 1).

According to an embodiment, the processor 220 may include at least one processor. The processor 220 may include a processing circuit. The processor 220 may execute various functions that are supported in the electronic device 200. The processor 220 may control at least some of the touch screen display 210, the processor 220, the memory 230, and the communication circuit 240. The processor 220 may execute a code that is written by a programming language stored in the memory 230 of the electronic device 200 to execute an application and to control a variety of hardware. For example, the processor 220 may refer to a plurality of processors that divide a plurality of operations thereamong to perform the plurality of operations collectively.

According to an embodiment, the processor 220 may include a driver circuit to detect a touch. The driver circuit may be electrically connected with the touch panel. The driver circuit may detect a touch input (e.g., touch down, long touch, swipe, drag, touch release) of a user received via the touch panel.

According to an embodiment, the driver circuit may identify data related to a user's touch input that may be received on the touch panel by using the touch sensor in the touch panel. For example, the driver circuit may identify data related to characteristics (e.g., whether a touch is performed, position (coordinates) of a touch point, a touch area, a touch sensitivity, a moving distance, a touch holding time, and/or whether the touch is released) related to the user's touch input.

According to an embodiment, the driver circuit may operate (e.g., supply power) the touch sensor in the touch panel, and may identify an electrical value (e.g., at least one of a voltage value or a current value) generated in the touch sensor in response to an input received based on supplied power, or a change in the electrical value. The driver circuit may identify data related to the user's touch input, based on the electrical value or the change in the electrical value identified.

In an embodiment, the driver circuit may include a first driver circuit and a second driver circuit. For example, the driver circuit may include the first driver circuit and the second driver circuit to detect different types of touch inputs. The first driver circuit may interlock with the first touch detection layer of the touch panel to detect a touch input using user's hand (e.g., finger, nail, or the like). The second driver circuit may interlock with the second touch detection layer of the touch panel to detect a touch input using an electronic pen (e.g., the electronic pen 500). However, the structure of the driver circuit is not limited thereto. For example, a single driver circuit may detect a touch input via one touch detection layer regardless of a type of an input tool (e.g., finger, an electronic pen).

According to an embodiment, the memory 230 (e.g., the memory 130 of FIG. 1) may store instructions that may cause the electronic device 200 to perform various operations when executed by the processor 220. For example, the processor 220 of the electronic device 200 may execute the instructions stored in the memory 230 to perform an image providing function.

According to an embodiment, the processor 220 may display a user interface for receiving a drawing via the touch screen display 210.

According to an embodiment, the processor 220 may display the user interface for receiving the drawing on the touch screen display 210 in response to a triggering event occurring. For example, the triggering event may include at least one of a first event in which a hovering input of an electronic pen (e.g., the electronic pen 500 of FIG. 5) is detected, a second event in which a user input (e.g., a touch) of selecting a predefined visual element within an edge area of the touch screen display 210 is detected, or a third event in which a user input (e.g., a touch) of selecting a predefined visual element within an application execution screen is detected.

According to an embodiment, the processor 220 may receive (or detect) a user's drawing via the touch screen display 210 in response to a first user input (e.g., touch, swipe, drag, gesture, stroke input, drawing input, handwriting input).

According to an embodiment, the processor 220 may determine a style of an image (image style) to be generated based on the user's drawing.

According to an embodiment, the processor 220 may display, on the touch screen display 210, a first interface element for selecting the style of the image to be generated from a plurality of predefined styles. The first interface element may be for selecting a style of an image to be generated (image style) as one of the plurality of predefined styles (e.g., watercolor, animation, pencil drawing, cartoon, neon, or actual image). The processor 220 may select one specific style (image style) from the plurality of predefined styles in response to a user input on the first interface element.

According to an embodiment, the processor 220 may receive a second user input (e.g., a touch on a predefined visual element) for generating an image corresponding to the user's drawing via the touch screen display 210.

According to an embodiment, the processor 220 may acquire description information on the drawing by using the drawing based on the second user input.

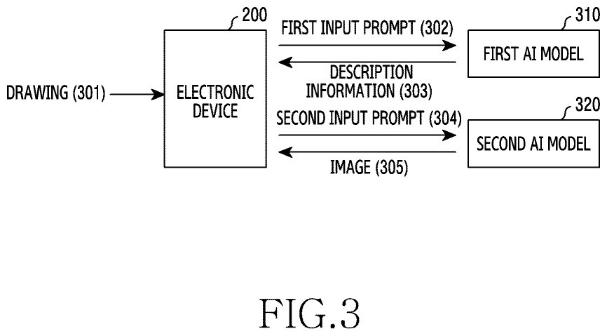

According to an embodiment, the processor 220 may provide a first input prompt including the drawing to a first AI model (e.g., a first AI model 310 of FIG. 3) in response to the second user input for generating the image, thereby acquiring description information on the drawing.

According to an embodiment, the processor 220 may determine (or set) a similarity between the user's drawing and the image to be generated.

According to various embodiments, the similarity may be indicated by other terms of the same or similar concept, such as a correlation, a dependency, or a ratio of reflection of the drawing on the image.

According to an embodiment, the similarity between the drawing (or a source image) and the image to be generated (or an output image) may have a defined default value.

According to an embodiment, the similarity between the drawing and the image to be generated may be changed based on at least one of a user input, a skill level of the drawing, a style of the image to be generated, or transparency of a drawing area.

According to an embodiment, the processor 220 may determine the similarity between the drawing and the image to be generated, based on a user input. The processor 220 may display a second interface element for selecting a similarity on the touch screen display 210. The processor 220 may determine the similarity based on a user input on the second interface element.

According to an embodiment, the processor 220 may adjust the similarity to a value lower than a default value in response to a first user input (e.g., swipe to the left) on the second interface element. For example, when the user is a novice user who is relatively unskilled at drawing, the user may adjust the similarity between the user's drawing and the image to be generated to a value lower than the default value by using the second interface element. Accordingly, an image that relatively reflects less of the user's drawing and depends relatively more on a training state of an AI model may be generated (or acquired).

According to an embodiment, the processor 220 may adjust the similarity to a value higher than the default value in response to a second user input (e.g., swipe to the right) on the second interface element. For example, when the user is an expert user who is relatively skilled at drawing, the user may adjust the similarity between the user's drawing and the image to be generated to a value higher than the default value by using the second interface element. Accordingly, an image that relatively reflects more of the user's drawing and depends on relatively less on the training state of the AI model may be generated (or acquired).

According to an embodiment, the processor 220 may determine the similarity between the drawing and the image to be generated, based on the style of the image to be generated (image style).

According to an embodiment, the processor 220 may display the first interface element for selecting the style of the image from the plurality of styles on the touch screen display 210. The processor 220 may set the similarity differently depending on the style selected in response to a user input on the first interface element. The processor 220 may set a length of the description information differently depending on the style selected by the user input on the first interface element.

According to an embodiment, the processor 220 may determine the similarity based on a skill level of the drawing. The processor 220 may set the similarity differently depending on the skill level of the drawing. For example, when the skill level of the drawing is a low level, the similarity may have a first value. When the skill level of the drawing is a high level, the similarity may have a second value that is higher than the first value.

According to an embodiment, the processor 220 may determine the similarity based on transparency of the drawing area for receiving the drawing. For example, the drawing area of the touch screen display 210 may display a reference image along which the user draws as a background image. The processor 220 may adjust the transparency of the drawing area in response to a user input (e.g., swipe horizontally) on a third interface element. As the transparency of the drawing area is higher (e.g., more transparent), the ratio of reflection of the drawing on the image to be generated may be lower, and the ratio of reflection of the reference image on the image may be higher. As the transparency of the drawing area is lower (more opaque), the ratio of reflection of the drawing on the image to be generated may be higher and the ratio of reflection of the reference image on the image may be lower.

According to an embodiment, the processor 220 may acquire (or generate) the image corresponding to the drawing, based on at least one of the drawing, the description information on the drawing, the similarity between the drawing and the image to be generated, the style of the image to be generated (image style), the skill level of the drawing, or the transparency of the drawing.

According to an embodiment, the processor 220 may acquire an image (an image corresponding to a drawing) generated based on a drawing and an image style.

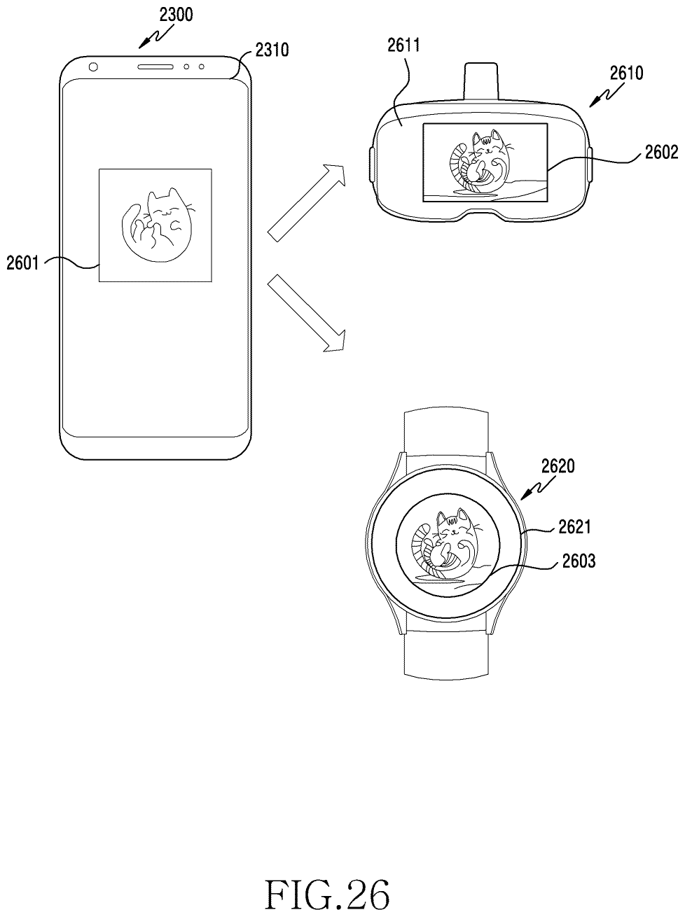

According to an embodiment, the processor 220 may provide an input prompt including a drawing and image style information to an AI model (e.g., a first AI model 310 and/or a second AI model 320 of FIG. 3), thereby acquiring (or generating) an image corresponding to the drawing. In an embodiment, the input prompt may further include at least a portion of a reference text (e.g., a text inputted via an input window) inputted by the user, a reference image (e.g., a background image displayed in the drawing area, a capture image on a background application execution screen), form factor information of the electronic device 200, or form factor information of an external electronic device (e.g., a first external electronic device 2610, a second external electronic device 2620 of FIG. 26) connected with the electronic device 200 via short-range wireless communication.

According to an embodiment, the processor 220 may acquire an image (e.g., an image corresponding to a drawing) generated based on at least a portion of description information on a drawing and a similarity between the drawing and an image to be generated.

According to an embodiment, the processor 220 may provide a first input prompt including a drawing to a first AI model (e.g., the first AI model 310 of FIG. 3), thereby acquiring description information on the drawing. The processor 220 may provide a second input prompt including at least a portion of the description information on the drawing and the similarity to an AI model (e.g., the second AI model 320 of FIG. 3), thereby acquiring (or generating) an image corresponding to the drawing. In an embodiment, the second input prompt may further include at least a portion of the drawing, image style information, a reference text inputted by the user, a reference image, form factor information of the electronic device 200, or the form factor information of an external electronic device connected with the electronic device 200 via short-range wireless communication.

According to an embodiment, the processor 220 may display the image (image corresponding to the drawing) acquired based on the drawing via the touch screen display 210.

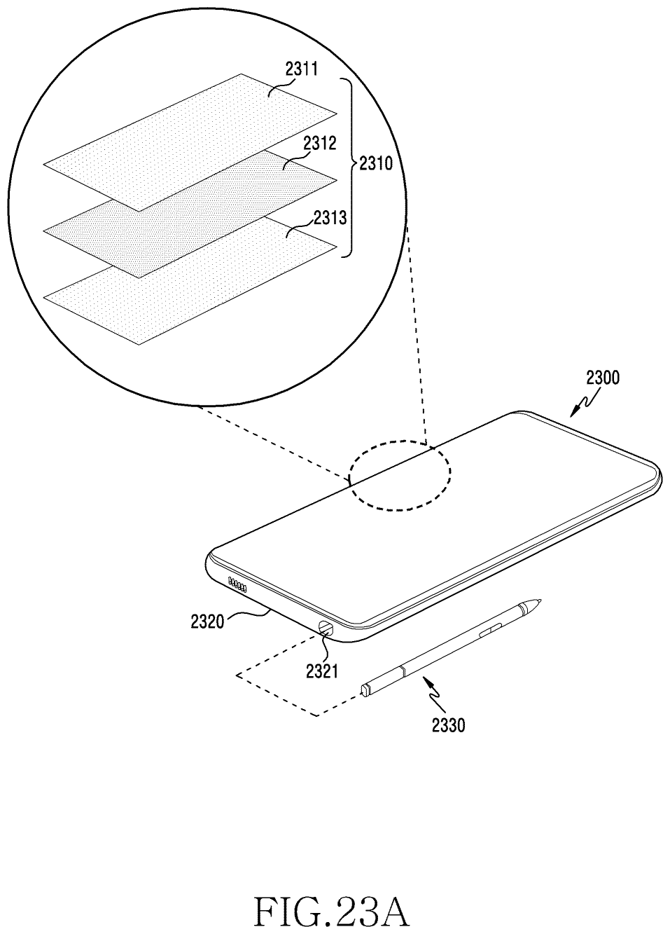

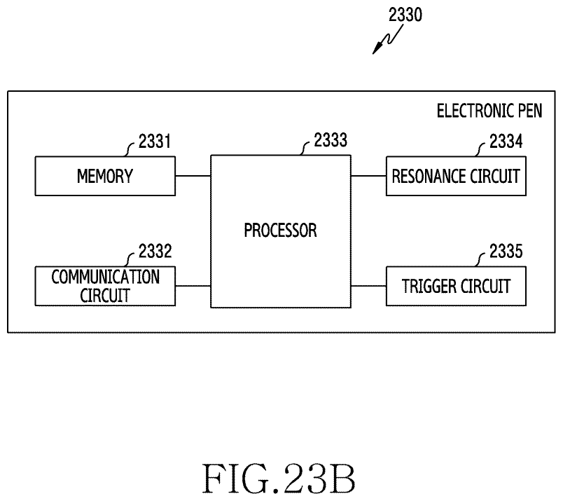

According to an embodiment, the electronic device 200 may be an electronic device (e.g., an electronic device 2300 of FIG. 23A) of a fixed form factor type.

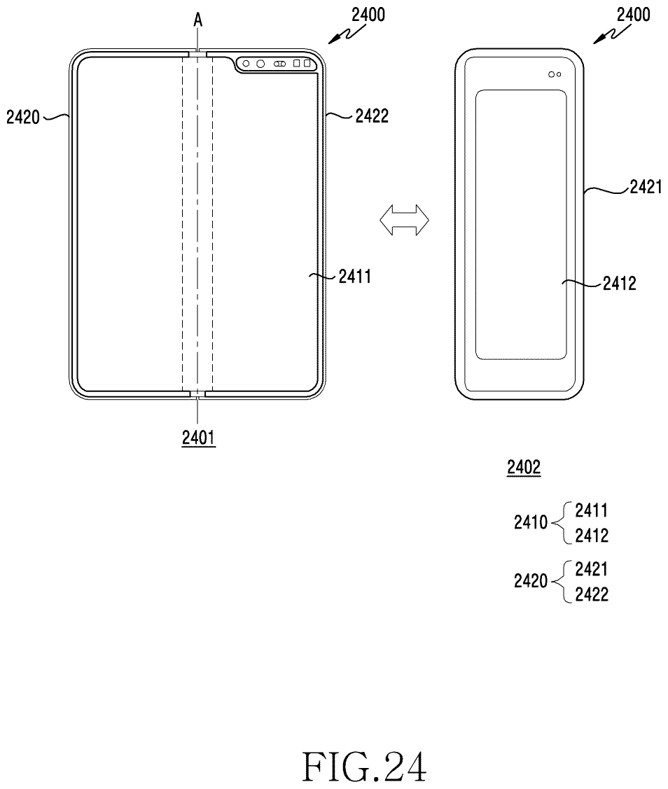

According to an embodiment, the electronic device 200 may be an electronic device (e.g., a foldable electronic device 2400 of FIG. 24) of a flexible form factor type that has a changeable form factor. The processor 220 of the electronic device 200 may include form factor information of the foldable electronic device in an input prompt to an AI model (e.g., the first AI model 310 and/or the second AI model 320 of FIG. 3). The processor 220 may acquire a plurality of images corresponding to the form factor information of the foldable electronic device in response to the input prompt.

According to an embodiment, the processor 220 may include form factor information of an external electronic device (or a target electronic device) in the input prompt to the AI model (e.g., the first AI model 310 and/or the second AI model 320 of FIG. 3). For example, the external electronic device may be a first external electronic device 2610 and/or a second external electronic device 2620 of FIG. 26. The processor 220 may acquire an image corresponding to the form factor information of the external electronic device in response to the input prompt.

According to an embodiment, the processor 220 may display a user interface including at least one keyword related to description information on a drawing via the touch screen display 210. The processor 220 may receive a user input on the at least one keyword via the user interface. The processor 220 may edit or modify (e.g., delete, correct, add) the description information on the drawing based on the user input. The processor 220 may acquire an image based on at least a portion of the edited description information.

According to an embodiment, the processor 220 may store the image corresponding to the drawing in the memory 230. The processor 220 may store at least one keyword related to description information on the drawing in metadata of the image when storing the image corresponding to the drawing. In an embodiment, the metadata of the image may further include detailed information corresponding to a time at which the image is stored, such as a position (or place), date, time.

According to an embodiment, the processor 220 may provide a search function on the plurality of images corresponding to the drawings, by using at least one keyword stored in the metadata of each image. The processor 220 may provide a search function on the plurality of images by additionally using detailed information of each image.

According to an embodiment, the electronic device 200 may acquire (or generate) an image corresponding to a drawing by using at least one AI model (e.g., the first AI model 310 and/or the second AI model 320 of FIG. 3).

According to an embodiment, the first AI model 310 and/or the second AI model 320 of FIG. 3 may be implemented by hardware and/or software to perform a predetermined function.

According to an embodiment, the electronic device of FIG. 2 may be configured to include at least a part of the first AI model 310 of FIG. 3 or the second AI model 320 of FIG. 3. The first AI model 310 and/or the second AI model 320 may be included in the electronic device 200 (e.g., the memory 230) in the form of an on-device AI model, but is not limited thereto. For example, at least a part of the first AI model 310 or the second AI model 320 may be included in an external server (e.g., the server 108 of FIG. 1). In an embodiment, the function of the first AI model 310 and the function of the second AI model 320 of FIG. 3 may be provided through one integrated AI model.

FIG. 3 is a view illustrating a plurality of AI models (e.g., a first AI model 310, and a second AI model 320) that may interlock with the electronic device 200, according to an embodiment.

According to an embodiment, the electronic device 200 may perform an image providing function by using a first AI model 310 and/or a second AI model 320.

Referring to FIG. 3, the first AI model 310 may be a generative AI model that may be trained for generating and/or providing description information 303 on a drawing 301 (or a source image). For example, the first AI model 310 may be a large multimodal model (LMM) AI model. However, the present disclosure is not limited in this regard.

According to an embodiment, the electronic device 200 may provide a first input prompt 302 including the drawing 301 to the first AI model 310, thereby acquiring the description information 303 on the drawing 301.

According to an embodiment, the first AI model 310 may receive the first input prompt 302 including the drawing 301. The first input prompt 302 may further include a text prompt (e.g., a text for requesting a simple description and/or a detailed description on the drawing 301, a text on a length of description information) on the drawing 301.

According to an embodiment, the first AI model 310 may generate the description information 303 on the drawing 301 based on the drawing 301 and/or the text prompt included in the first input prompt 302. The first AI model 310 may transmit the generated description information 303 to the electronic device 200.

Referring to FIG. 3, the second AI model 320 may be a generative AI model that may be trained for generating and/or providing an image 305 (or an output image) corresponding to the drawing 301 (or source image). For example, the second AI model 320 may be an image generation AI model (e.g., a text to image diffusion model AI model). However, the present disclosure is not limited in this regard.

According to an embodiment, the electronic device 200 may provide a second input prompt 304 including at least a portion of the description information 303 on the drawing 301 to the second AI model 320, thereby acquiring the image 305 corresponding to the drawing 301.

According to an embodiment, the second AI model 320 may receive the second input prompt 304 including at least a portion of the description information 303 on the drawing 301. The second input prompt 304 may further include a similarity between the drawing 301 and the image 305 to be generated.

In an embodiment, the second input prompt 304 may further include at least one of the drawing 301, image style information, a reference text inputted by a user, a reference image, form factor information of the electronic device 200, or form factor information of an external electronic device connected with the electronic device via short-range wireless communication.

According to an embodiment, the second AI model 320 may generate the image 305 corresponding to the drawing 301 based on the second input prompt 304. The second AI model 320 may transmit the image 305 that is generated in response to the second input prompt 304 to the electronic device 200.

According to an embodiment, the function of the first AI model 310 and the function of the second AI model 320 of FIG. 3 may be provided through one integrated AI model. In this case, the integrated AI model may skip the process of generating description information on the drawing and transmitting the description information to the electronic device 200 (e.g., the processor 220). The integrated AI model may directly generate an image corresponding to the drawing by using the description information generated therein. In an embodiment, the image corresponding to the drawing may be generated by using the drawing as it is without the process of generating description information on the drawing.

According to an embodiment, the electronic device 200 may provide an input prompt including at least one of the drawing 301, the description information 303 on the drawing, the similarity between the drawing 301 and the image to be generated, or the image style information to an AI model (e.g., the second AI model 320 or the integrated AI model), thereby acquiring (or generating) an image corresponding to the drawing. In an embodiment, the input prompt may further include at least one of a reference text inputted by the user, a reference image, form factor information of the electronic device 200, or form factor information of an external electronic device connected with the electronic device via short-range wireless communication.

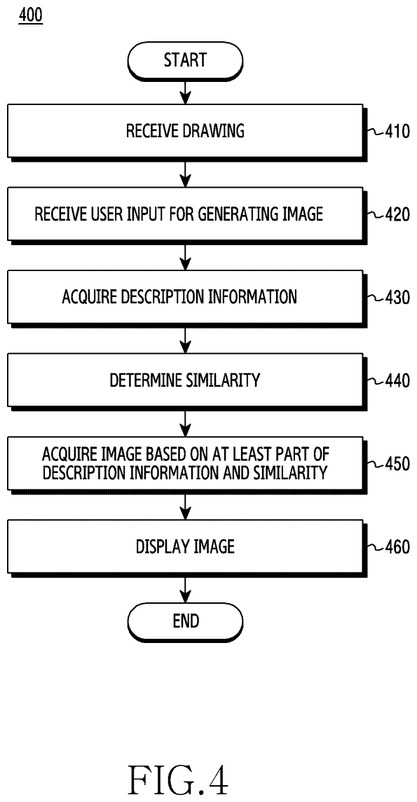

FIG. 4 is a flowchart illustrating an image providing method of the electronic device 200, according to an embodiment.

According to an embodiment, the electronic device 200 may generate an image corresponding to a drawing, based on at least a portion of a user's drawing, description information on the drawing, and a similarity.

Referring to FIG. 4, the image providing method 400 of the electronic device 200 may include operation 410, operation 420, operation 430, operation 440, operation 450, and operation 460. In an embodiment, some of the illustrated operations may be omitted, some operations may be integrated, the order of some operations may be changed, or other operations may be added.

In operation 410, the electronic device 200 (e.g., the processor 220) may display a user interface (e.g., a first screen 510 of FIG. 5) for receiving a drawing on the touch screen display 210. The electronic device 200 may receive (or detect) a drawing (e.g., a first drawing 551, or a second drawing 552 of FIG. 5) in response to a first user input (e.g., touch, swipe, drag, gesture, stroke input, drawing input, handwriting input) via the touch screen display 210.

According to an embodiment, the drawing may include at least one line (or stroke) and/or figure. The drawing may include a first drawing (e.g., the first drawing 551 of FIG. 5) corresponding to a sketch (or a drawing). The drawing may further include a second drawing (e.g., the second drawing 552 of FIG. 5) corresponding to a text. The drawing may further include color data.

According to an embodiment, the electronic device 200 may receive a drawing (e.g., the first or second drawings 551 or 552) inputted by a user via a user interface (e.g., a second screen 520 of FIG. 5) displayed on the touch screen display 210.

According to an embodiment, the electronic device 200 (e.g., the processor 220) may receive a drawing that is inputted on the touch screen display 210 by the user using an electronic pen (e.g., an electronic pen 500 of FIG. 5) (or finger). The electronic device 200 may display the received drawing on the touch screen display 210 in real time. The electronic device 200 may detect the drawing drawn by the user via a touch sensor in the touch screen display 210. However, the present disclosure is not limited in this regard. For example, the electronic device 200 may detect the drawing drawn by the user by sensing a user gesture by using a motion sensor (e.g., a motion sensor, a gesture sensor, a proximity sensor in the sensor module 176) and/or a camera (e.g., at least one camera in the camera module 180). For example, the electronic device 200 may detect a drawing drawn by the user using an input tool such as a separate input pad (drawing pad) and/or a mouse.

In operation 420, the electronic device 200 (e.g., the processor 220) may receive (or detect) a second user input for generating an image corresponding to the drawing via the touch screen display 210. For example, the electronic device 200 may receive the second user input for generating an image (e.g., an image corresponding to the first or second drawing 551 or 552) in response to the user touching an image generation button 541 in the user interface like the second screen 520 of FIG. 5.

In operation 430, the electronic device 200 (e.g., the processor 220) may acquire description information on the drawing by using the drawing (e.g., the first or second drawing 551 or 552 of FIG. 5), based on the second user input received in operation 420.

According to an embodiment, the description information on the drawing may include a text depicting the drawing. For example, the text depicting the drawing may include at least a portion of one or more keywords related to the drawing or an object (e.g., an animal object, a thing object, a person object, a background object, a handwriting object) in the drawing, natural language sentences related to the one or more keywords, or natural language sentences explaining the drawing or the context of an object in the drawing.

According to an embodiment, in operation 430, the electronic device 200 may acquire the description information on the drawing by providing a first input prompt including the drawing to a first AI model (e.g., the first AI model 310 of FIG. 3) in response to the second user input (e.g., a touch on the image generation button 541 of FIG. 5) received through operation 420.

According to an embodiment, the electronic device 200 may display, on the touch screen display 210, a first interface element (e.g., a first interface element 511 of FIG. 5) for selecting a style of the image to be generated from a plurality of styles. The first interface element may be for selecting the style of the image to be generated (image style) as one of a plurality of predefined styles (e.g., watercolor, animation, pencil drawing, cartoon, neon, or actual image). The electronic device 200 may determine a length of the description information, based on the style selected by a user input on the first interface element. For example, when the style selected by the user is a first style (e.g., cartoon, neon for which intuitiveness may be important), a simple description may be advantageous to generating the image. In this case, the electronic device 200 may set the length of the description information to a first length that is relatively short, so that description information of a simple version may be acquired. For example, when the style selected by the user is a second style (e.g., watercolor, pencil drawing for which precise descriptions are important), the quality of the image to be generated may be higher as the description is more detailed. In this case, the electronic device 200 may set the length of the description information to a second length that is relatively long, so that the description information of the detailed version may be acquired.

According to an embodiment, at least a portion of the description information on the drawing may be received from the user. For example, when the user writes a text with a keyboard via an input window in the user interface displayed on the touch screen display 210, the text may be used as a portion of the description information on the drawing.

In operation 440, the electronic device 200 (e.g., the processor 220) may determine (or identify) a similarity between the drawing and the image to be generated.

According to various embodiments, the similarity may be indicated by other terms of the same or similar concept, such as a correlation, dependency, or a ratio of reflection of the drawing on the image.

The term “similarity” is selected for the convenience of explanation, and it is obvious to persons having an ordinary skill in the art (“those skilled in the art”) that the similarity is indicated by various terms indicating a degree of consideration (or reflection) of user's drawing on an image to be generated by AI.

According to an embodiment, the similarity may be a value indicating how the drawing (or source image) is similar to the image (or output image) to be generated. The similarity may be a value indicating how the drawing and the image to be generated are related to each other (correlation). The similarity may be a value indicating a degree of influence of the drawing on the image to be generated and/or a degree of dependence (dependency) of the image. The similarity may be a value indicating a ratio of reflection of the drawing on the image to be generated.

According to an embodiment, the similarity may be indicated by a weight value of a range that is greater than zero (0) and smaller than one (1). The similarity may be indicated by a percentage value of a range that is greater than 0% and smaller than 100%.

According to an embodiment, as the similarity is closer to zero (0 or 0%), an image (or an output image) that has a relatively larger difference (or distance, for example, an Euclidean distance, a structural similarity index (SSIM), a histogram difference, characteristic information difference) from the drawing (or source image) may be obtained. As the similarity is closer to one (1 or 100%), an image (or an output image) that has a relatively smaller difference (or distance) from the drawing (or source image) may be obtained.

According to an embodiment, the similarity may be a value indicating a ratio of reflection of the drawing on the image to be generated. The similarity may be related to a ratio of reflection of the drawing on the image or a probability that characteristic data of the drawing is included in the image. For example, the characteristic data of the drawing may include data related to at least a portion of the number of strokes (or lines) in the drawing, attributes of the strokes (e.g., length, position, shape, thickness or complexity), an outline of an object in the drawing, a size of the object, a position of the object, dot/line/surface forming the object, coloring, or color).

According to an embodiment, as the similarity is lower, the ratio of reflection of the drawing on the image or the probability that the characteristic data of the drawing is included in the image may be lower. As the similarity is higher, the ratio of reflection of the drawing on the image or the probability that the characteristic data of the drawing is included in the image may also be higher.

According to an embodiment, the similarity between the drawing and the image to be generated may be determined to be a defined default value (e.g., one value pre-set from 0.4, 0.6, 0.8, or 1).

According to an embodiment, the similarity between the drawing and the image to be generated may be determined based on at least one of a user input, a skill level of the drawing, a style of the image to be generated, or transparency of the drawing area.

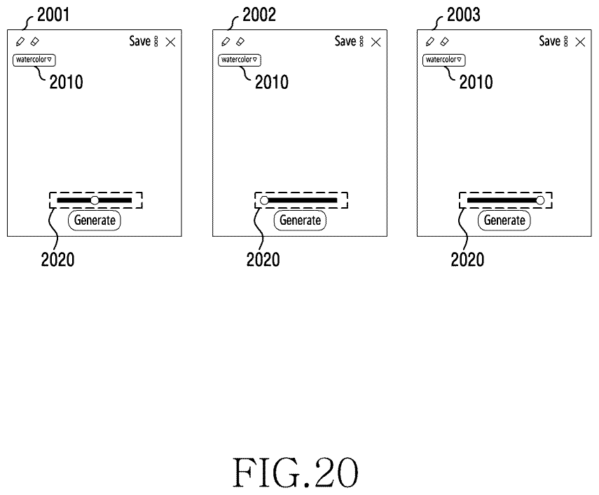

According to an embodiment, the similarity between the drawing and the image to be generated may be determined based on a user input. The electronic device 200 may display a user interface including a second interface element (e.g., a second interface element 2020 of FIG. 20) for selecting a similarity on the touch screen display 210. The electronic device 200 may determine the similarity based on a user input on the second interface element. The electronic device 200 may adjust the similarity to a value lower than a default value in response to the user input on the second interface element. For example, when the user selects the similarity as a value of a low range (e.g., less than or equal to 0.4) from a low range, an intermediate range, and a high range by using the second interface element 2020 of FIG. 20, the similarity may be adjusted to a first value (e.g., 0.4) that is lower than the default value (e.g., 0.6) when there is no separate user input on the second interface element 2020. For example, when the user selects the similarity as a value of a high range (e.g., greater than or equal to 0.8) using the second interface element 2020 of FIG. 20, the similarity may be adjusted to a second value (e.g., 0.8) that is higher than the default value (e.g., 0.6).

According to an embodiment, the similarity between the drawing and the image to be generated may be determined based on a style of the image to be generated. The electronic device 200 may determine the similarity differently depending on the style of the image to be generated.

According to an embodiment, the electronic device 200 may display a user interface including the first interface element (e.g., the first interface element 2010 of FIG. 20) for selecting the style of the image to be generated on the touch screen display 210. The electronic device 200 may select the style of the image to be generated in response to a user input on the first interface element. The electronic device 200 may set the similarity differently depending on the selected style. For example, when the style selected by the user is a first style (e.g., cartoon, neon sign that may need intuitive descriptions), the electronic device 200 may set the similarity between the drawing and the image to be generated to a first value (e.g., 0.4) belonging to a relatively low range. For example, when the style selected by the user is a second style (e.g., watercolor, pencil drawing that may need precise descriptions), the electronic device 200 may set the similarity between the drawing and the image to be generated to a second value (e.g., 0.8) belonging to a relatively high range and higher than the first value.

According to an embodiment, the similarity between the drawing and the image to be generated may be determined based on a skill level of the drawing. The electronic device 200 may set the similarity between the drawing and the image to be generated differently depending on the skill level of the drawing.

According to an embodiment, as the skill level of the drawing is higher, the similarity between the drawing and the image to be generated may be set to a higher value. As the skill level of the drawing is lower, the similarity between the drawing and the image to be generated may be set to a lower value.

According to an embodiment, when the skill level of the drawing is a low level, the similarity between the drawing and the image to be generated may have a first value (e.g., 0.4). When the skill level of the drawing is a high level, the similarity between the drawing and the image may have a second value (e.g., 0.8) that is higher than the second value.

According to an embodiment, the electronic device 200 may determine the similarity between the drawing and the image to be generated, based on transparency of the drawing area for receiving the drawing. For example, a reference image along which the user draws may be displayed on the drawing area of the touch screen display 210 as a background image. In this state, as the transparency of the drawing area is higher (more transparent), the ratio of reflection of the drawing on the image to be generated may be lower and the ratio of reflection of the reference image on the image may be higher. As the transparency of the drawing area is lower (more opaque), the ratio of reflection of the drawing on the image to be generated may be higher and the ratio of reflection of the reference image on the image may be lower.

In operation 450, the electronic device 200 (e.g., the processor 220) may acquire an image (e.g., an image 560 of FIG. 5) that is generated based on at least a portion of the description information acquired through operation 430, and the similarity between the drawing and the image, which is determined through operation 440. The electronic device 200 (e.g., the processor 220) may acquire cause a new image (e.g., an image 560 of FIG. 5) to be generated based on at least a portion of the description information acquired through operation 430, and the similarity which is determined through operation 440.

According to an embodiment, the electronic device 200 may acquire the description information on the drawing by providing the first input prompt including the drawing (e.g., the first or second drawing 551 or 552 of FIG. 5) to the first AI model (e.g., the first AI model 310 of FIG. 3) in response to the second user input (e.g., a touch on the image generation button 541) for generating the image. The electronic device 200 may acquire the image corresponding to the drawing by providing a second input prompt including at least a portion of the description information and the similarity to a second AI model (e.g., the second AI model 320 of FIG. 3).

According to an embodiment, the similarity may have at least one value of a defined default value, a user setting value, a value corresponding to the style of the image to be generated (or image style), a value corresponding to the skill level of the drawing, a value corresponding to the transparency of the drawing area.

According to an embodiment, the second input prompt may further include at least a portion of the drawing, image style information, a reference text inputted by the user (e.g., a text inputted via an input window), a reference image (e.g., a background image displayed on the drawing area, a captured image on a background application execution screen), form factor information of the electronic device 200, or form factor information of an external electronic device (e.g., the first external electronic device 2610, the second external electronic device 2620 of FIG. 26) connected with the electronic device 200 via short-range wireless communication.

According to an embodiment, the electronic device 200 may display a user interface including at least one keyword related to the description information on the drawing via the touch screen display 210. The electronic device 200 may receive a user input on the at least one keyword via the user interface. The electronic device 200 may edit the description information based on the user input. In this case, the image corresponding to the drawing may be acquired (or generated) based on at least a portion of the edited description information.

In operation 460, the electronic device 200 may display the image (e.g., the image 560 of FIG. 5) acquired through operation 450 via the touch screen display 210.

FIG. 5 illustrates examples of user interfaces to explain an image providing method of the electronic device 200, according to an embodiment.

Referring to FIG. 5, the electronic device 200 may display user interfaces such as a first screen 510, a second screen 520, and a third screen 530 via the touch screen display 210. The first screen 510, the second screen 520, and the third screen 530 may be for the image providing function. For example, the first screen 510, the second screen 520, and the third screen 530 may be execution screens of a predefined application (e.g., a drawing application, a note application) that is being executed in the electronic device 200.

The first screen 510 may be a user interface that includes a drawing area for receiving drawings (e.g., the first and second drawings 551 and 552) from a user.

The second screen 520 may be a user interface that displays the first and second drawings 551 and 552 that the user draws in the drawing area with the electronic pen 500 (or finger) in real time.

The second screen 520 may include an image generation button 541.

The third screen 530 may be a user interface that displays an image 560 acquired (or generated) based on the first and second drawings 551 and 552. The electronic device 200 may acquire the image 560 corresponding to the first and second drawings 551 and 552 inputted by the user in response to the user touching the image generation button 541, and may display the acquired image 560.

According to an embodiment, the electronic device 200 may receive the first and second drawings 551 and 552 that may be inputted by the user via the drawing area displayed via the touch screen display 210. The first drawing 551 may correspond to a sketch (or a drawing). For example, the sketch may include at least one line (or stroke) and/or figure. The second drawing 552 may correspond to a text. For example, the text may include at least one of a handwritten text, a letter, a sign, or a memo that is inputted by the user.

According to an embodiment, the electronic device 200 may use the second drawing 552 along with the first drawing 551 to generate an image. For example, when the user sketches a cat and handwrites “Russian”, the electronic device 200 may acquire the image 560 on a cat of a Russian gloomy breed by using the first drawing 551 that is a result of sketching a cat, and the second drawing 552 of “Russian”. In another example, when the user expresses a house by drawing a triangle on a square and handwrites “brick”, the electronic device 200 may acquire an image on a brick house by using the first drawing expressing a house and the second drawing of “brick”.

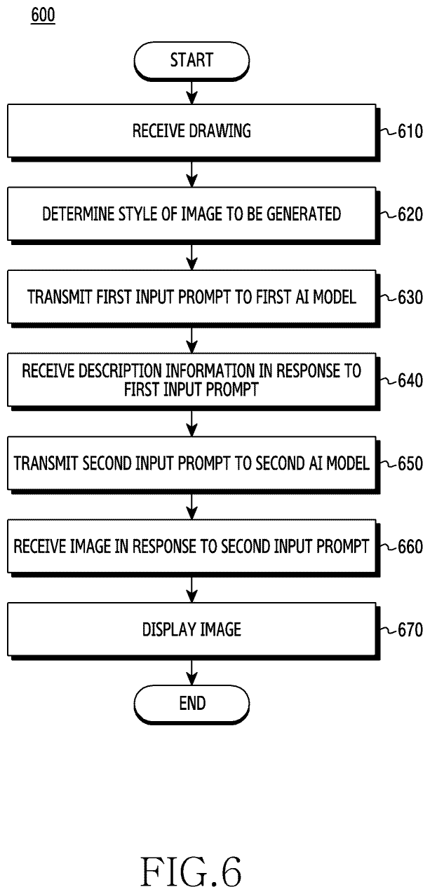

FIG. 6 is a flowchart illustrating a method of providing an image by using a plurality of AI models (e.g., a first AI model 310, and a second AI model 320) in the electronic device 200, according to an embodiment.

Referring to FIG. 6, the image providing method 600 of the electronic device 200 may include operation 610, operation 620, operation 630, operation 640, operation 650, operation 660, and operation 670.

According to an embodiment, at least some of the operations illustrated in FIG. 6 may correspond to the operations of FIG. 4. For example, operation 610 of FIG. 6 may correspond to operation 410 of FIG. 4. Operations 630 and 640 of FIG. 6 may correspond to operation 430 of FIG. 4. Operations 650 and 660 of FIG. 6 may correspond to operation 450 of FIG. 4. Operation 670 of FIG. 6 may correspond to operation 460 of FIG. 4. At least some of the operations illustrated in FIG. 6 may be performed in combination with at least some of the operations of FIG. 4.

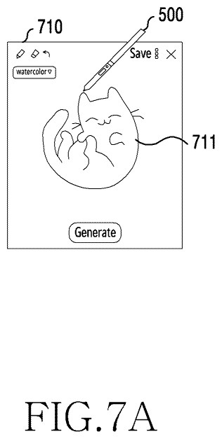

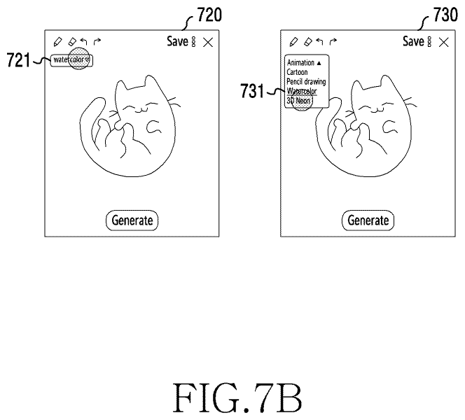

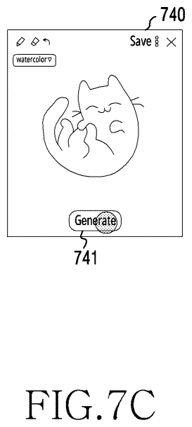

In operation 610, the electronic device 200 may receive a drawing via the touch screen display 210 displaying a user interface (e.g., a first screen 710 of FIG. 7A) in response to a first user input.

According to an embodiment, the drawing may include at least one line (or stroke) and/or a figure that is inputted by the user. The drawing may include a first drawing corresponding to a sketch (or a drawing). The drawing may further include a second drawing corresponding to a text. The drawing may further include color data.

In operation 620, the electronic device 200 may determine a style of an image to be generated (image style), based on the drawing.

According to an embodiment, the electronic device 200 may provide a list of a plurality of styles via a user interface (e.g., a first interface element 721 in a second screen 720 of FIG. 7B) displayed on the touch screen display 210, thereby enabling the user to select one of the plurality of styles. For example, the plurality of styles may include two (2) or more of watercolor, animation, pencil drawing, cartoon, neon or actual image. The electronic device 200 may determine the style selected by the user from the plurality of styles as the style of the image to be generated.

In operation 630, the electronic device 200 may transmit a first input prompt to a first AI model (e.g., the first AI model 310 of FIG. 3).

According to an embodiment, the first input prompt may be for requesting a description (e.g., a simple description and/or a detailed description) on the drawing received through operation 610. For example, the first input prompt may be transmitted in response to the user touching an image generation button 741 of FIG. 7C. The first input prompt may include the drawing received through operation 610.

According to an embodiment, the first input prompt may include a length of description information (e.g., a fixed default length).

According to an embodiment, the length of the description information included in the first input prompt (e.g., a first length for the detailed description or a second length for the simple description may be set differently depending on the style of the image to be generated. The electronic device 200 may set the length of the description information differently depending on the style of the image to be generate.

According to an embodiment, the electronic device 200 may display, on the touch screen display 210, a user interface including the first interface element (e.g., the first interface element 721 of FIG. 7B) for selecting the style of the image to be generated. The electronic device 200 may select the style of the image to be generated in response to a user input on the first interface element. The electronic device 200 may determine the length of the description information based on the selected style. The electronic device 200 may set the length of the description information differently depending on the selected style. For example, when the style selected by the user is a first style (e.g., cartoon, neon for which intuitiveness is important), a simple description may be advantageous to generating the image. In this case, the electronic device 200 may set the length of the description information to a first length that is relatively short, so that a simple description may be requested. For example, when the style selected by the user is a second style (e.g., watercolor, pencil drawing for which precise descriptions are important), the quality of the image to be generated may be higher as the description is more detailed. In this case, the electronic device 200 may set the length of the description information to a second length that is relatively long, so that a detailed description may be requested.

In operation 640, the electronic device 200 may receive description information on the drawing from the first AI model (e.g., the first AI model 310 of FIG. 3) in response to the first input prompt transmitted in operation 630.

In operation 650, the electronic device 200 may transmit a second input prompt to a second AI model (e.g., the second AI model 320 of FIG. 3).

According to an embodiment, the second input prompt may be for requesting generation of an image by using the description information received through operation 640. The second input prompt may include at least a portion of the description information on the drawing, and a similarity between the drawing and the image to be generated. For example, the similarity may have at least one value of a defined default value, a user setting value, a value corresponding to the style of the drawing, a value corresponding to the skill level of the drawing, a value corresponding to transparency of the drawing area.

According to an embodiment, the second input prompt may further include at least a portion of the drawing, image style information, a reference text inputted by the user, a reference image, form factor information of the electronic device 200, or form factor information of an external electronic device connected with the electronic device 200 via short-range wireless communication.

According to an embodiment, the electronic device 200 may fully include the description information received through operation 640 in the second input prompt.

According to an embodiment, the electronic device 200 may include only a portion of the description information on the drawing, which is received through operation 640, in the second input prompt, and may filter the rest of the description information. For example, the electronic device 200 may delete or correct an unnecessary text (e.g., a word and/or sentence) from the description information on the drawing prior to transmitting the second input prompt. For example, the electronic device 200 may delete or correct a text including a typical or comprehensive meaning. For example, the electronic device 200 may store a text list to be filtered (e.g., a simple, a line drawing of, a sketch of, a painting of, a drawing of, black, white, the doodle) in the memory 230, and may delete or correct one or more words and/or sentences from the description information on the drawing based on the text list.

In operation 660, the electronic device 200 may receive an image corresponding to the drawing from the second AI model (e.g., the second AI model 320 of FIG. 3) in response to the second input prompt transmitted in operation 650.

In operation 670, the electronic device 200 may display the image acquired through operation 660 via the touch screen display 210.

FIGS. 7A, 7B, and 7C illustrate examples of user interfaces to explain the process (e.g., operation 620 of FIG. 6) of determining the style in the electronic device 200, according to an embodiment.

Referring to FIGS. 7A, 7B, and 7C, the electronic device 200 may display user interfaces such as a first screen 710, a second screen 720, a third screen 730, and a fourth screen 740 to determine a style.

Referring to FIG. 7A, the electronic device 200 may display the first screen 710 via the touch screen display 210 including a touch screen 211. The first screen 710 may be a user interface including a drawing area for receiving a sketch 711 (or drawing) from the user. The electronic device 200 may receive the sketch 711 in response to the user inputting the sketch 711 to the drawing area of the first screen 710 with an electronic pen 712 (or finger).

Referring to FIG. 7B, the second screen 720 may be a user interface including a first interface element 721. The first interface element 721 may be for selecting the style of the image to be generated. The first interface element 721 may provide a list of a plurality of styles to enable the user to select one of the plurality of styles. For example, when the user selects a main menu (e.g., a dialogue box) corresponding to the first interface element 721 within the second screen 720, a drop-down menu window 731 may be displayed like the third screen 730. The drop-down menu window 731 may display a list of sub-menus indicating the plurality of styles. For example, the plurality of styles may include at least a part of watercolor, animation, pencil drawing, cartoon, or 3D neon.

When the user selects one of the plurality of styles included in the drop-down menu window 731 within the third screen 730, the electronic device 200 may determine the selected style as the style of the image to be generated based on the sketch 711.

Referring to FIG. 7C, the fourth screen 740 may be a user interface including an image generation button 741. The image generation button 741 may be an interface element for requesting generation of the image. In response to the user selecting a desired style via the first interface element 721 of FIG. 7B and touching the image generation button 741 of FIG. 7C, the electronic device 200 may acquire an image corresponding to the sketch 711. The image may be an image of the style selected via the first interface element 721.

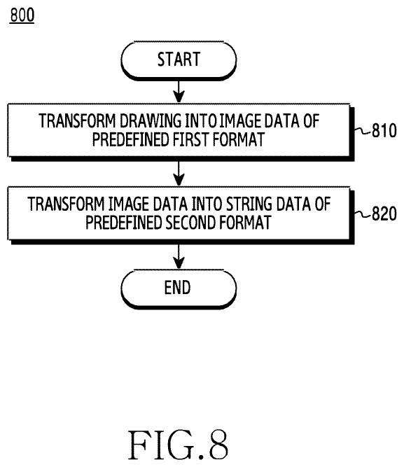

FIG. 8 is a flowchart illustrating a process of generating a first input prompt in the electronic device 200, according to an embodiment.

According to an embodiment, the process 800 (e.g., operation 630 of FIG. 6) of transmitting the first input prompt by the electronic device 200 may include operation 810 and operation 820. Operations 810 and 820 may be for generating the first input prompt that requests description information on a drawing.

Referring to FIG. 8, in operation 810, the electronic device 200 may transform a drawing (e.g., the sketch 711 of FIG. 7A) inputted by a user into image data of a predefined first format. For example, the electronic device 200 may transform the sketch 711 into the image data of the first format (e.g., bmp data) in response to a user input on the image generation button 741 of FIG. 7C.

In operation 820, the electronic device 200 may transform the image data of the first format transformed through operation 810 into string data of a second format. For example, the electronic device 200 may transform and/or encode the image data of the first format (e.g., bmp data) transformed from the drawing (e.g., the sketch 711) into the string data of the second format (e.g., string data of a base 64 type).

According to an embodiment, the electronic device 200 may generate the first input prompt including both the image data of the first format on the drawing (image prompt) and the string data of the second format on the drawing (text prompt). The electronic device 200 may provide the first input prompt to a first AI model (e.g., the first AI model 310 of FIG. 3), thereby receiving description information on the drawing from the first AI model.

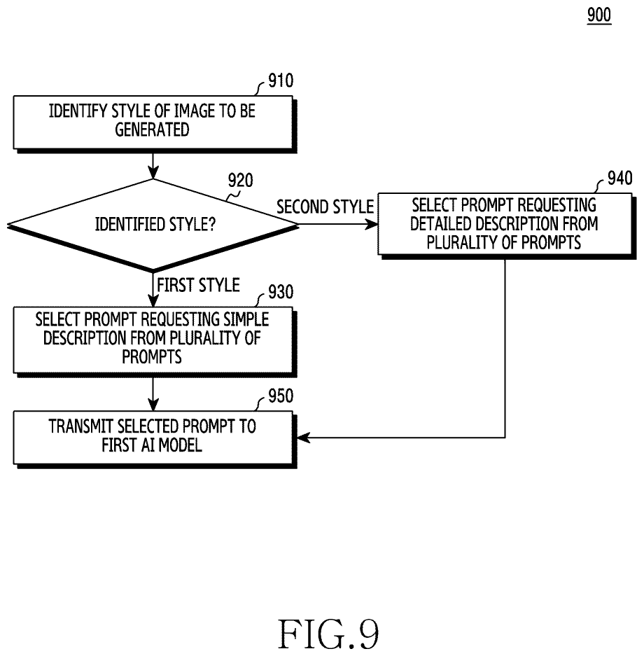

FIG. 9 is a flowchart illustrating a process of generating a first input prompt based on a style in the electronic device 200, according to an embodiment.

According to an embodiment, a process 900 of transmitting a first input prompt by the electronic device 200 (e.g., operation 630 of FIG. 6) may include operation 910, operation 920, operation 930, operation 940, and operation 950. Operation 910, operation 920, operation 930, operation 940, and operation 950 may be for generating a first input prompt for requesting description information on a drawing.

Referring to FIG. 9, in operation 910, the electronic device 200 may identify a style of an image to be generated (or an output image) based on a drawing (or source image). For example, the electronic device 200 may identify a style that is selected from a plurality of predefined styles by the user via a user interface (e.g., the first interface element 721 of FIG. 7B).

In operation 920, the electronic device 200 may identify whether the style identified through operation 910 is a first style (e.g., cartoon, neon that may need intuitive descriptions) or a second style (e.g., watercolor, pencil drawing that may need detailed descriptions).

When the style identified in operation 920 is the first style (e.g., cartoon, neon for which intuitiveness may be important) (FIRST STYLE in operation 920), the electronic device 200 may proceed to operation 930. In operation 930, the electronic device 200 may select a prompt requesting a simple description from a plurality of prompts (e.g., text prompts) pre-stored in the memory 230.

When the style identified in operation 920 is the second style (e.g., watercolor, pencil drawing that may need detailed descriptions) (SECOND STYLE in operation 920), the electronic device 200 may proceed to operation 940. In operation 940, the electronic device 200 may select a prompt requesting a detailed description from the plurality of pre-stored prompts (e.g., text prompts).

In operation 950, the electronic device 200 may transmit the prompt that is selected through operation 930 or 940 to the first AI model 310 as the first input prompt requesting the description on the drawing.

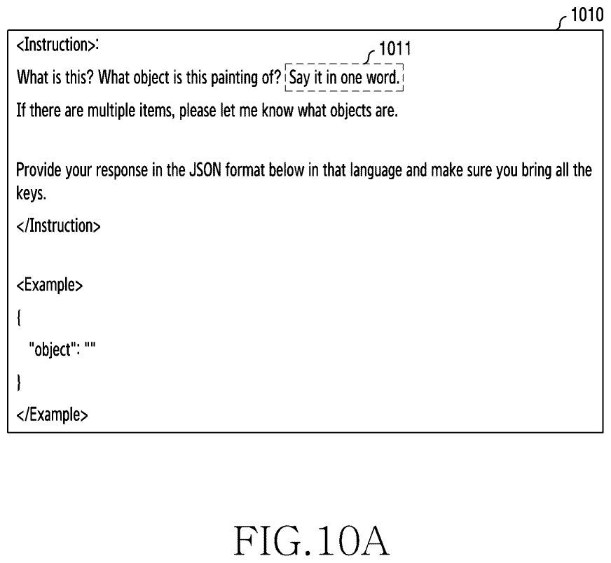

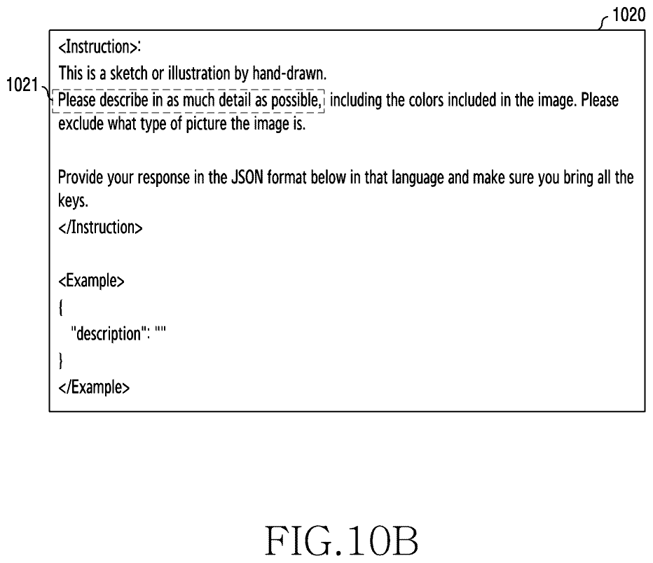

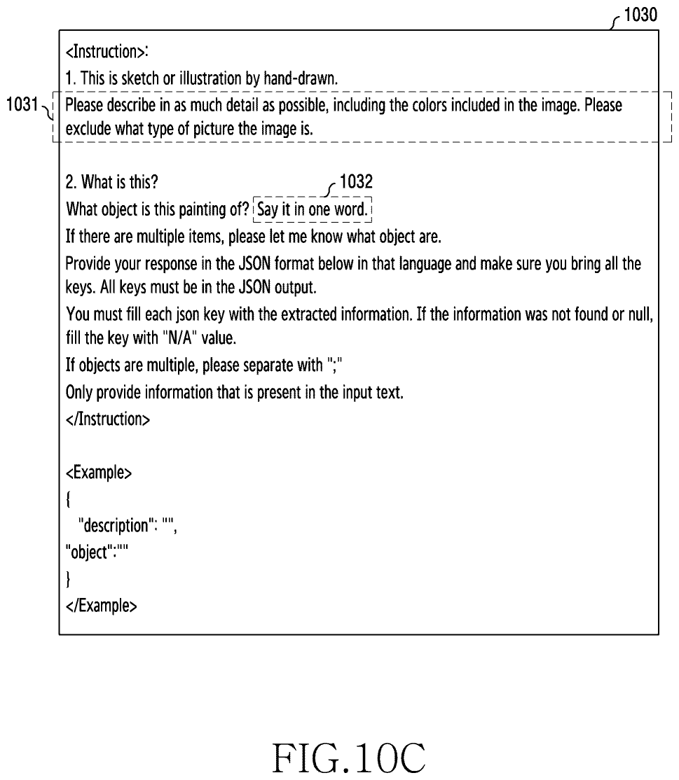

FIG. 10A illustrates an example of a first input prompt that requests a simple description on a drawing, according to an embodiment.

According to an embodiment, the first input prompt that requests the description on the drawing may include a first text prompt 1010 (e.g., a prompt selected in operation 930 of FIG. 9) that requests a simple description.

Referring to FIG. 10A, the first text prompt 1010 may include one or more natural language sentences. The first text prompt 1010 may include a phrase 1011 requesting a simple description.

FIG. 10B illustrates an example of a first input prompt that requests a detailed description on a drawing, according to an embodiment.

According to an embodiment, the first input prompt that requests the description on the drawing may include a second text prompt 1020 (e.g., a prompt selected in operation 940 of FIG. 9) that requests a detailed description.

Referring to FIG. 10B, the second text prompt 1020 may include one or more natural language sentences. The second text prompt 1020 may include a phrase 1021 requesting a detailed description.

FIG. 10C illustrates an example of a first input prompt that requests both a simple description and a detailed description on a drawing, according to an embodiment.

According to an embodiment, the first input prompt that requests the description on the drawing may include a third text prompt 1030 that requests both a simple description and a detailed description on one drawing.

Referring to FIG. 10C, the third text prompt 1030 may include one or more natural language sentences. The third text prompt 1030 may include a phrase 1031 requesting a detailed description on the drawing, and a phrase 1032 requesting a simple description on the drawing.

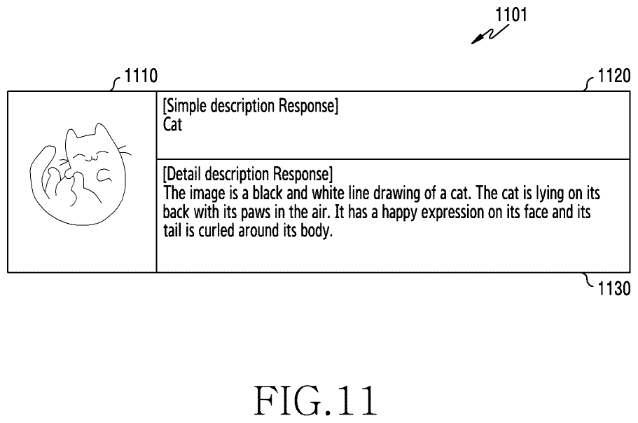

FIG. 11 illustrates an example of a response 1101 to a first input prompt, according to an embodiment.

According to an embodiment, the electronic device 200 may transmit a first input prompt requesting a description on a sketch 1110 to the first AI model 310.

The electronic device 200 may receive a response 1101 to the first input prompt from the first AI model 310. The response 1101 may include the sketch 1110 (or a source image, a drawing). The response 1101 may include a simple description portion 1120 and/or a detailed description portion 1130 on the sketch 1110.

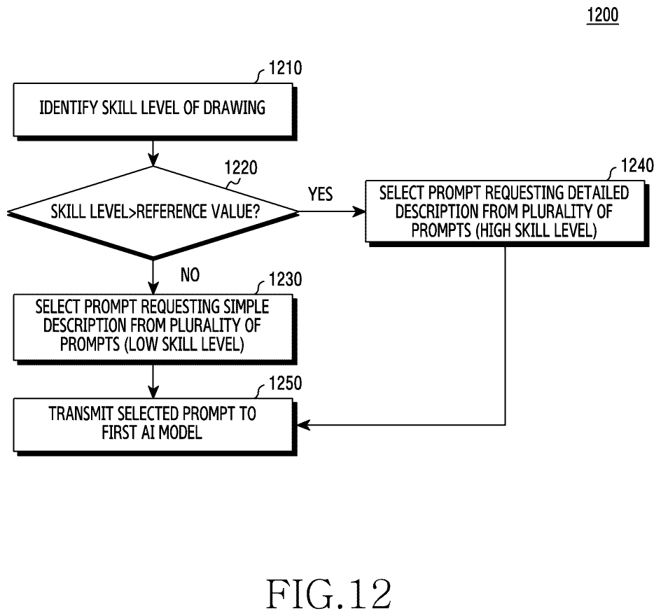

FIG. 12 is a flowchart illustrating a process of generating a first input prompt based on a skill level in the electronic device 200, according to an embodiment.

According to an embodiment, a process 1200 of transmitting a first input prompt by the electronic device 200 (e.g., operation 630 of FIG. 6) may include operation 1210, operation 1220, operation 1230, operation 1240, and operation 1250. Operation 1210, operation 1220, operation 1230, operation 1240, and operation 1250 may be for generating a first input prompt that requests description information on a drawing.

Referring to FIG. 12, in operation 1210, the electronic device 200 may determine a skill level of a drawing (or a source image).

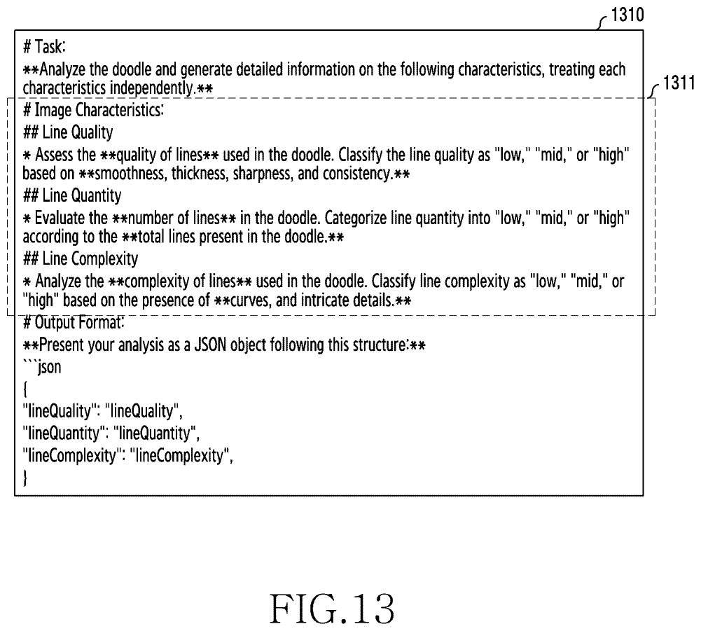

According to an embodiment, the electronic device 200 may transmit a request (e.g., a third input prompt 1310 of FIG. 13) for inquiring about the skill level of the drawing to an AI model (e.g., the first AI model 310 of FIG. 3), and may receive a skill level as a response to the request.

According to an embodiment, the electronic device 200 may score and/or determine the skill level of the drawing (e.g., one of a low level or a high level) by analyzing characteristic data of the drawing. For example, the characteristic data of the drawing may include data on at least a portion of the number of stroke lines in the drawing, attributes (e.g., length, position, shape, thickness or complexity) of the stroke lines, an outline of an object within the drawing, a size of the object, a position of the object, dot/line/surface forming the object, or coloring.

According to an embodiment, the electronic device 200 may determine the skill level of the drawing, based on user information stored in the memory 230. For example, the user information may include at least one of a user level (e.g., one of an amateur level or a professional level), a drawing application subscription period of the user, an amount of accumulated user's drawings.

In operation 1220, the electronic device 200 may identify whether the skill level of the drawing determined through operation 1210 is higher than a predefined reference value.

When the skill level of the drawing is lower than the reference value (the skill level is a low level) as a result of identifying in operation 1220 (NO is operation 1220), the electronic device 200 may proceed to operation 1230. In operation 1230, the electronic device 200 may select a prompt that requests a simple description from a plurality of prompts (e.g., text prompts) pre-stored in the memory 230.

When the skill level of the drawing is higher than the reference value (the skill level is a high level) as a result of identifying in operation 1220 (YES in operation 1220), the electronic device 200 may proceed to operation 1240. In operation 1240, the electronic device 200 may select a prompt that requests a detailed description from the plurality of prompts (e.g., text prompts) pre-stored in the memory 230.

In operation 1250, the electronic device 200 may transmit the prompt selected through operation 1230 or 1240 to the first AI model 310 as the first input prompt requesting the description on the drawing.

FIG. 13 illustrates an example of a third input prompt that requests determination of a skill level, according to an embodiment.

According to an embodiment, the electronic device 200 may determine a skill level of a drawing based on the drawing inputted by the user. For example, the electronic device 200 may transmit the third input prompt 1310 for inquiring about the skill level of the drawing to the first AI model 310.

Referring to FIG. 13, the third input prompt 1310 may include a portion 1311 that requests scoring evaluation of each item on the drawing and/or a skill level according to the scoring evaluation of each item. For example, the portion 1311 may be for requesting scoring evaluation (e.g., one of a low level, a middle level, or a high level) about at least one item of quality evaluation on the drawing, the number of stroke lines in the drawing, lengths of the stroke lines, or complexity of the stroke lines, and/or a skill level (e.g., one of a low level or a high level) according to the scoring evaluation.

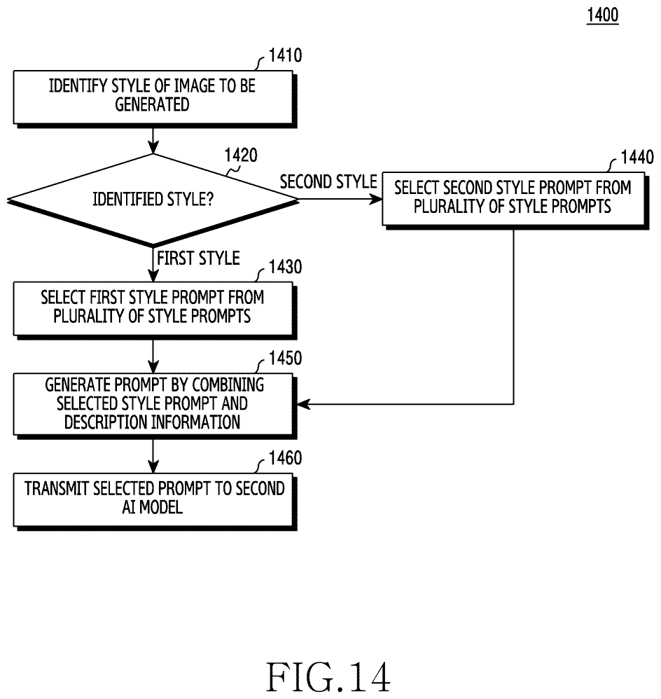

FIG. 14 is a flowchart illustrating a process of generating a second input prompt based on a style in the electronic device 200, according to an embodiment.

According to an embodiment, a process 1400 (e.g., operation 650 of FIG. 6) of transmitting a second input prompt by the electronic device 200 may include operation 1410, operation 1420, operation 1430, operation 1440, operation 1450, and operation 1460. Operation 1410, operation 1420, operation 1430, operation 1440, operation 1450, and operation 1460 may be for generating a second input prompt for requesting generation of an image corresponding to a drawing.

Referring to FIG. 14, in operation 1410, the electronic device 200 may identify a style of an image to be generated (or an output image) based on a drawing (or a source image). For example, the electronic device 200 may identify a style that is selected from a plurality of predefined styles (e.g., at least two (2) of watercolor, animation, pencil drawing, cartoon, or neon) by a user via a user interface (e.g., the first interface element 721 of FIG. 7B).

In operation 1420, the electronic device 200 may identify whether the style identified through operation 1410 is a first style (e.g., cartoon, neon that may need intuitive descriptions) or a second style (e.g., watercolor, pencil drawing that may need precise descriptions).

When the style identified through operation 1420 is the first style (e.g., cartoon, neon for which intuitiveness may be important) (FIRST STYLE in operation 1420), the electronic device 200 may proceed to operation 1430. In operation 1430, the electronic device 200 may select a style prompt (or first image style information, for example, a text indicating one style of cartoon or neon) indicating the style identified in operation 1410.

When the style identified through operation 1420 is the second style (e.g., watercolor, pencil drawing that may need precise descriptions) (SECOND STYLE in operation 1420), the electronic device 200 may proceed to operation 1440. In operation 1440, the electronic device 200 may select a style prompt (or second image style information, for example, a text indicating one style of watercolor or pencil drawing) indicating the style identified in operation 1410.

In operation 1450, the electronic device 200 may generate a prompt by combining the style prompt (or image style information) selected through operation 1430 or operation 1440 and description information on the drawing. For example, the electronic device 200 may generate a prompt (e.g., one or more natural language sentences) by combining the style prompt (or first image style information) selected through operation 1430, and a simple description portion (e.g., a text corresponding to the simple description portion 1120 of FIG. 11) extracted from the description information on the drawing. For example, the electronic device 200 may generate a prompt (e.g., one or more natural language sentences) by combining the style prompt (or second image style information) selected through operation 1440, and a detailed description portion (e.g., a text corresponding to the detailed description portion 1130 of FIG. 11) extracted from the description information on the drawing.

In operation 1460, the electronic device 200 may transmit the prompt generated through operation 1450 to the second AI model 320 as the second input prompt requesting generation of the image.

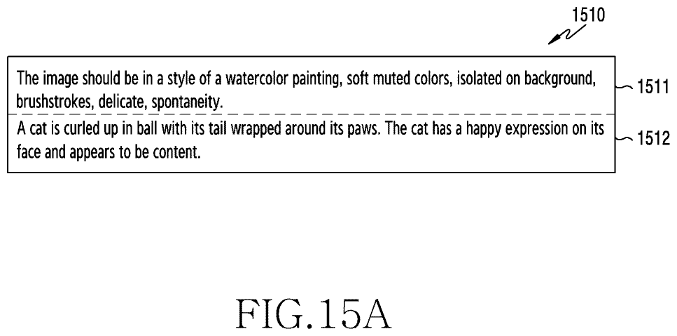

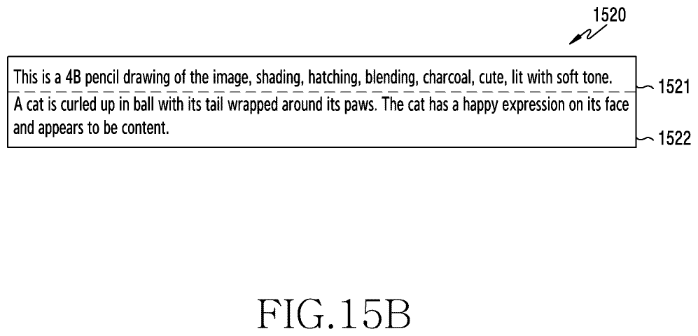

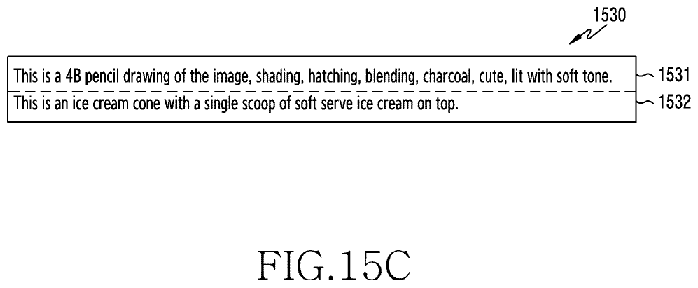

FIGS. 15A, 15B, and 15C illustrate examples of a second input prompt requesting generation of an image, according to an embodiment.

Referring to FIG. 15A, the second input prompt that requests generation of an image may include a first text prompt 1510. For example, when the user inputs a drawing of a cat shape (e.g., the sketch 711 of FIG. 7A) and selects a watercolor style via a user interface (e.g., the first interface element 721 of FIG. 7B), the electronic device 200 may generate the first text prompt 1510 as shown in FIG. 15A. The first text prompt 1510 may include a style prompt (or first style information, for example: natural language sentence indicating a watercolor style) 1511 regarding the watercolor style, and description information (e.g., one or more natural language sentences explaining a cat object) 1512 regarding the cat object in the drawing.

Referring to FIG. 15B, the second input prompt that requests generation of an image may include a second text prompt 1520. For example, when the user inputs a drawing of a cat shape (e.g., the sketch 711 of FIG. 7A) and selects a pencil drawing style via a user interface (e.g., the first interface element 721 of FIG. 7B), the electronic device 200 may generate the second text prompt 1520 as shown in FIG. 15B. The second text prompt 1520 may include a style prompt (or second style information, for example: natural language sentence indicating a pencil drawing style) 1521 regarding the pencil drawing style, and description information (e.g., one or more natural language sentences explaining a cat object) 1522 regarding the cat object in the drawing.

Referring to FIG. 15C, the second input prompt that requests generation of an image may include a third text prompt 1530. For example, when the user inputs a drawing of an ice cream shape and selects a pencil drawing style via a user interface (e.g., the first interface element 721 of FIG. 7B), the electronic device 200 may generate the third text prompt 1530 as shown in FIG. 15C. The third text prompt 1530 may include a style prompt (or second style information, for example: natural language sentence indicating a pencil drawing style) 1531 regarding the pencil drawing style, and description information (e.g., one or more natural language sentences explaining an ice cream object) 1532 regarding the ice cream object in the drawing.

According to an embodiment, the order of arrangement of sentences in the second input prompt may vary according to the selected style. For example, in the case of the watercolor style, sentences may be arranged in order of style information and description information, and in the case of the pencil drawing style, sentences may be arranged in order of description information and style information.

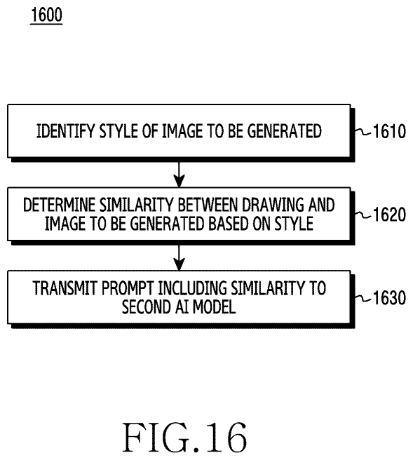

FIG. 16 is a flowchart illustrating a process of generating a second input prompt based on a similarity by style in the electronic device 200, according to an embodiment.

According to an embodiment, a process 1600 (e.g., operation 650 of FIG. 6) of transmitting a second input prompt by the electronic device 200 may include operation 1610, operation 1620, operation 1630.

Referring to FIG. 16, in operation 1610, the electronic device 200 may identify a style of an image to be generated (or an output image) based on a drawing (or a source image). For example, the electronic device 200 may identify a style that is selected from a plurality of predefined styles (e.g., at least two (2) of watercolor, animation, pencil drawing, cartoon, or neon) by a user via a user interface (e.g., the first interface element 721 of FIG. 7B).

In operation 1620, the electronic device 200 may determine a similarity between the drawing and an image to be generated, based on the style identified through operation 1610. The similarity may vary according to the style of the image to be generated. The electronic device 200 may determine the similarity to be included in the second input prompt differently depending on the style of the image to be generated. For example, when a first style (e.g., cartoon, neon that may need intuitive descriptions) is selected from the plurality of styles, the electronic device 200 may determine the similarity between the drawing and the image to be generated to be a first value (e.g., 0.4) belonging to a relatively low range. For example, when a second style (e.g., watercolor, pencil drawing that may need precise descriptions) is selected from the plurality of styles, the electronic device 200 may determine the similarity between the drawing and the image to be generated to be a second value (e.g., 0.8) belonging to a relatively high range and higher than the first value.

In operation 1630, the electronic device 200 may generate a prompt including the similarity determined through operation 1620. The electronic device 200 may transmit the generated prompt to the second AI model 320 as the second input prompt requesting generation of an image.

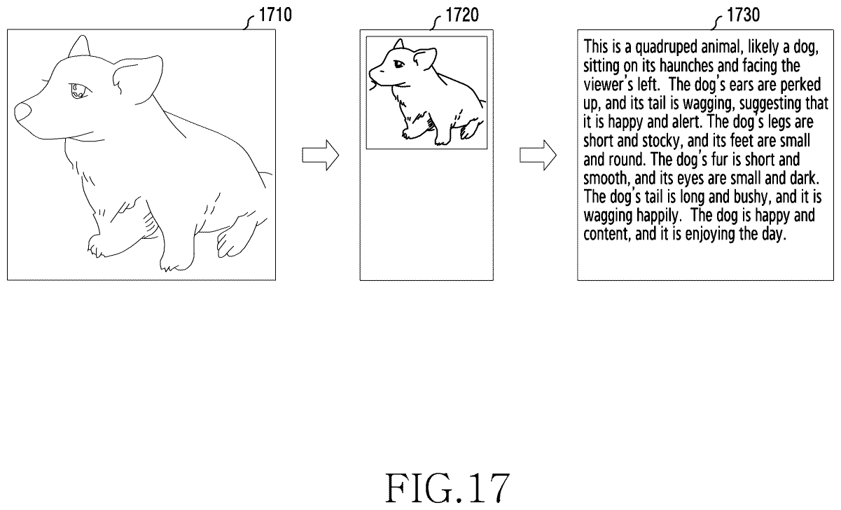

FIG. 17 illustrating an example of description information on a drawing, according to an embodiment.

Referring to FIG. 17, the electronic device 200 may receive a sketch 1710 (or a source image, a drawing) of a dog shape that is inputted by a user. The electronic device 200 may transform the sketch 1710 into image data 1720 of a predefined first format (e.g., bmp data). The electronic device 200 may acquire description information 1730 on the sketch 1710 by providing the image data 1720 of the first format (e.g., bmp data) to the first AI model 310. For example, the description information 1730 on the sketch 1710 may include one or more natural language sentences depicting the dog object in the sketch 1710.

According to an embodiment, the electronic device 200 may transform and/or encode the image data 1720 of the first format transformed from the sketch 1710 into string data of a second format (e.g., string data of a base 64 type) although this is not illustrated in FIG. 17.

According to an embodiment, the electronic device 200 may generate a first input prompt including both the image data 1720 of the first format on the sketch 1710 and the string data (text prompt) of the second format on the sketch 1710. The electronic device 200 may receive the description information 1730 on the sketch 1710 from the first AI model 310 by providing the first input prompt to the first AI model 310.

According to an embodiment, the electronic device 200 may display a user interface (e.g., a message window, a speech bubble) including at least one keyword related to the description information on the drawing (e.g., the sketch 1710 of FIG. 17). The electronic device 200 may receive a user input on the at least one keyword via the user interface. The electronic device 200 may edit (e.g., delete, correct, add) the description information based on the user input. The electronic device 200 may acquire an image that is generated based on the edited description information by providing the edited description information to the second AI model (e.g., the second AI model 320 of FIG. 3).

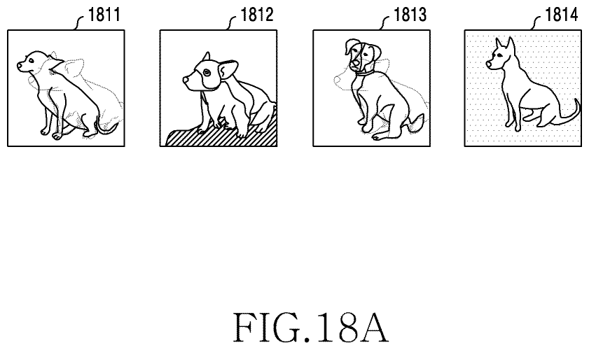

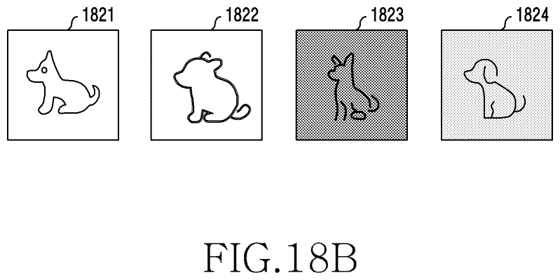

FIGS. 18A and 18B illustrate examples of images that may be acquired based on a similarity by style, according to an embodiment.

According to an embodiment, the electronic device 200 may acquire a plurality of images (e.g., output images of various versions) corresponding to a drawing (or source image) inputted by a user, based on a style and/or a similarity by style.

Referring to FIG. 18A, when the sketch 1710 of the dog shape shown in FIG. 17 is inputted by the user and a watercolor style is selected form the plurality of styles, the electronic device 200 may determine the similarity between the drawing and the image to be generated to be a second value (e.g., 0.8) that matches the watercolor style. The electronic device 200 may generate a prompt including the description information 1730 on the sketch 1710, the second value (e.g., 0.8) indicating the determined similarity, and the number of necessary images (e.g., four (4)). The electronic device 200 may acquire a plurality of images (e.g., a first image 1811, a second image 1812, a third image 1813, and a fourth image 1814) of various versions from the second AI model 320 as shown in FIG. 18A by providing the generated prompt to the second AI model 320 as the second input prompt requesting generation of the image.

Referring to FIG. 18A, the first image 1811, the second image 1812, the third image 1813, and the fourth image 1814 may be watercolor style images that may be generated based on the description information 1730 on the sketch 1710 of the dog shape of FIG. 17 and are generated to have the similarity of the second value (e.g., 0.8) compared to the sketch 1710. For example, the images of various versions (e.g., the first image 1811, the second image 1812, the third image 1813, and the fourth image 1814) shown in FIG. 18A may be images depicting different breeds of dogs generated to correspond to the pose of the dog object in the sketch 1710 or features of key areas (e.g., the direction that the head faces, the shapes of legs or tail).

Referring to FIG. 18B, when the sketch 1710 of the dog shape shown in FIG. 17 is inputted by the user and a neon style is selected form the plurality of styles, the electronic device 200 may determine the similarity between the drawing and the image to be generated to be a first value (e.g., 0.4) that matches the neon style. The electronic device 200 may generate a prompt including the description information 1730 on the sketch 1710, the first value (e.g., 0.4) indicating the determined similarity, and the number of necessary images (e.g., four (4)). The electronic device 200 may acquire a plurality of images (e.g., a first image 1821, a second image 1822, a third image 1823, and a fourth image 1824) of various versions from the second AI model 320 as shown in FIG. 18B by providing the generated prompt to the second AI model 320 as the second input prompt requesting generation of the image.

Referring to FIG. 18B, the first image 1821, the second image 1822, the third image 1823, and the fourth image 1824 may be neon style images that may be generated based on the description information 1730 on the sketch 1710 of the dog shape of FIG. 17 and are generated to have the similarity of the first value (e.g., 0.4) compared to the sketch 1710. For example, the images of various versions (e.g., the first image 1821, the second image 1822, the third image 1823, and the fourth image 1824) shown in FIG. 18B may be simplified dog characters of different shapes (e.g., characters to which neon lights having different colors, effects are applied) generated to correspond to the pose of the dog object in the sketch 1710 or features of key areas (e.g., the direction that the head faces, the shapes of legs or tail).

The first to fourth images 1821 to 1824 of FIG. 18B (watercolor style images generated based on the similarity of 0.8) may be relatively less reflective of the user's sketch 1710 than the first to fourth images 1811 to 1814 of FIG. 18A (neon style images generated based on the similarity of 0.4).

As the similarity is closer to 0.1, more randomized image generation results may be obtained compared to the similarity of 1.0. In addition, as the similarity is closer to 0.1, image generation results may be more dependent on the training state of an AI model compared to the similarity of 1.0.

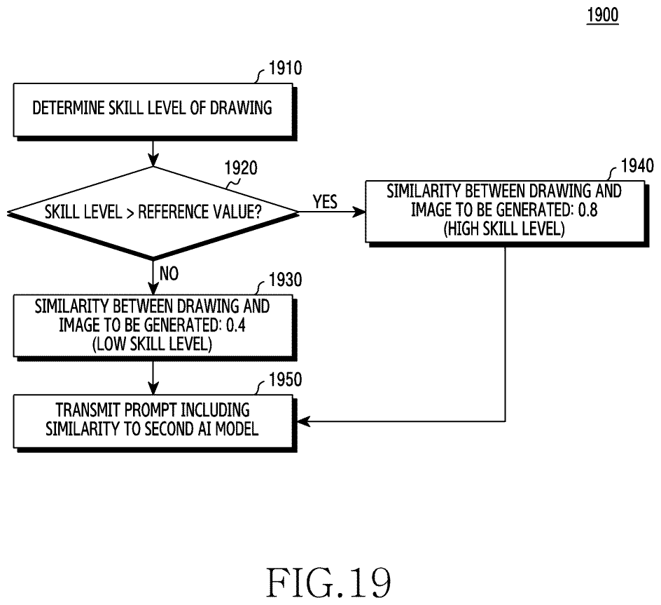

FIG. 19 is a flowchart illustrating a process of generating a second input prompt based on a similarity by skill level in the electronic device 200, according to an embodiment.

According to an embodiment, a process 1900 (e.g., operation 650 of FIG. 6) of transmitting a second input prompt by the electronic device 200 may include operation 1910, operation 1920, operation 1930, operation 1940, and operation 1950.

Referring to FIG. 19, in operation 1910, the electronic device 200 may determine a skill level of a drawing (or a source image). Operation 1910 may correspond to operation 1210 of FIG. 12.

In operation 1920, the electronic device 200 may identify whether the skill level of the drawing determined through operation 1910 is higher than a predefined reference value.

When the skill level of the drawing is lower than the reference value (when the skill level is a low level) as a result of identifying in operation 1920 (NO in operation 1920), the electronic device 200 may proceed to operation 1930. In operation 1930, the electronic device 200 may determine the similarity between the drawing and the image to be generated to be a first value (e.g., 0.4).

When the skill level of the drawing is higher than the reference value (when the skill level is a high level) as a result of identifying in operation 1920 (YES in operation 1920), the electronic device 200 may proceed to operation 1904. In operation 1940, the electronic device 200 may determine the similarity between the drawing and the image to be generated to be a second value (e.g., 0.8) that may be higher than the first value (e.g., 0.4).

As described above, the electronic device 200 may determine the similarity between the drawing and the image to be generated differently depending on the skill level of the drawing.

In operation 1950, the electronic device 200 may generate a prompt including the similarity determined in operation 1930 or 1940. The electronic device 200 may transmit the generated prompt to the second AI model 320 as the second input prompt requesting generation of the image.

FIG. 20 is a view illustrating examples of user interfaces to explain a process of determining a similarity in the electronic device 200, according to an embodiment.

Referring to FIG. 20, the electronic device 200 may display a user interface such as a first screen 2001, a second screen 2002, or a third screen 2003. The first screen 2001, the second screen 2002, or the third screen 2003 may include a first interface element 2010 and/or a second interface element 2020.

The first interface element 2010 may be for selecting a style of an image to be generated (image style) from a plurality of predefined styles (e.g., watercolor, illustration, sketch, pop-art, 3D cartoon, no style or random style).

The second interface element 2020 may be for changing the similarity in response to a user input (e.g., a touch input, a swipe input, a direct digit input, a digit selection input, an input of selecting one level of high/intermediate/low levels, or whether an option is checked).

According to an embodiment, the electronic device 200 may determine the similarity between the user's drawing and the image to be generated, based on an image style selected via the first interface element 2010 and/or a user input on the second interface element 2020. The electronic device 200 may include the similarity in a second input prompt for requesting generation of the image. The electronic device 200 may provide the second input prompt including the similarity to the second AI model 320.

According to an embodiment, as the similarity between the drawing and the image to be generated is lower, the probability that characteristic data of the drawing is included in the image (or ratio of reflection of the drawing on the image) may be lower. As the similarity between the drawing and the image to be generated is higher, the probability that characteristic data of the drawing is included in the image (or ratio of reflection of the drawing on the image) may also be higher.

According to an embodiment, the electronic device 200 may set the similarity differently depending on the image style selected via the first interface element 2010.

The electronic device 200 may set a similarity default vale that matches each of the plurality of styles. For example, a relatively high default value (e.g., 0.8) may be set for a first style (e.g., watercolor, illustration). A default value of an intermediate range (e.g., 0.6) may be set for a second style (e.g., sketch, pop-art, 3D cartoon). A relatively low default value (e.g., 0.4) may be set for a third style (e.g., a random style, no style).

For example, when the watercolor style is selected as an image style and a user input does not occur on the second interface element 2020 in the first screen 2001, the similarity may be set to a default value (e.g., 0.8) that matches the watercolor style. When the user changes the image style to the 3D cartoon style by using the first interface element 2010, the similarity may be changed to a default value (e.g., 0.6) that matches the 3D cartoon style.

According to an embodiment, the electronic device 200 may set the similarity differently depending on a user input on the second interface element 2020.

For example, when a user input does not occur on the second interface element 2020, the similarity may be set to a defined default value (e.g., 0.5). The first screen 2001 shows a state in which the similarity indicated by the second interface element 2020 is set to a default value of an intermediate range (e.g., 0.5).

For example, when a swipe input in a first direction (e.g., swipe to the left) occurs on the second interface element 2020, the similarity may be changed to a value of a low range (e.g., less than or equal to 0.3). The second screen 2002 shows a state in which the similarity indicated by the second interface element 2020 is changed to a minimum value (0 or 0%) in response to the swipe input in the first direction. When the similarity is set to the minimum value, the second AI model 320 may generate an image by using only the description information on the drawing without considering characteristic data of the drawing.

For example, when a swipe input in a second direction (e.g., swipe to the right) opposite to the first direction occurs on the second interface element 2020, the similarity may be changed to a value (e.g., greater than or equal to 0.7) of a high range. The third screen 2003 shows a state in which the similarity indicated by the second interface element 2020 is changed to a maximum value (1 or 100%) in response to the swipe input in the second direction. When the similarity is set to the maximum value, the second AI model 320 may generate an image by fully reflecting the characteristic data of the drawing along with the description information on the drawing.

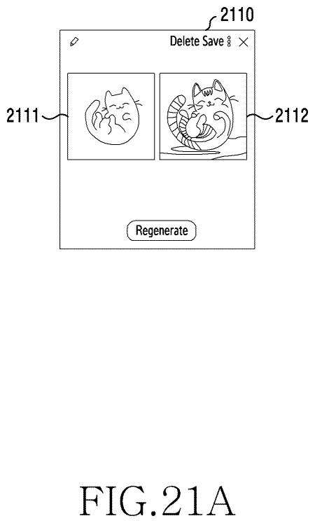

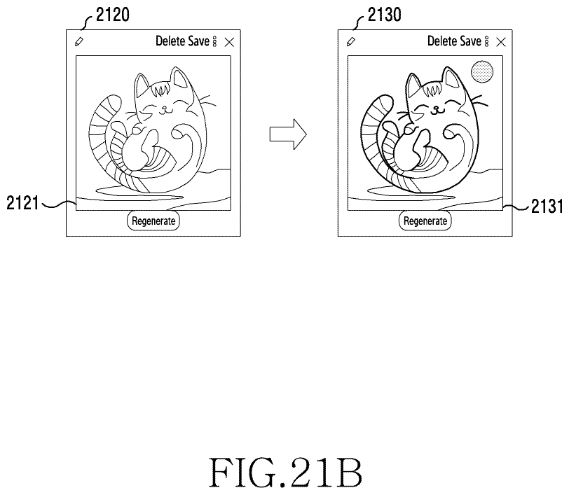

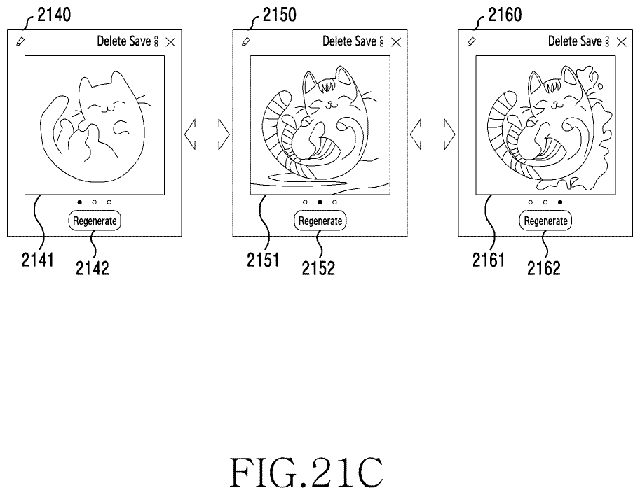

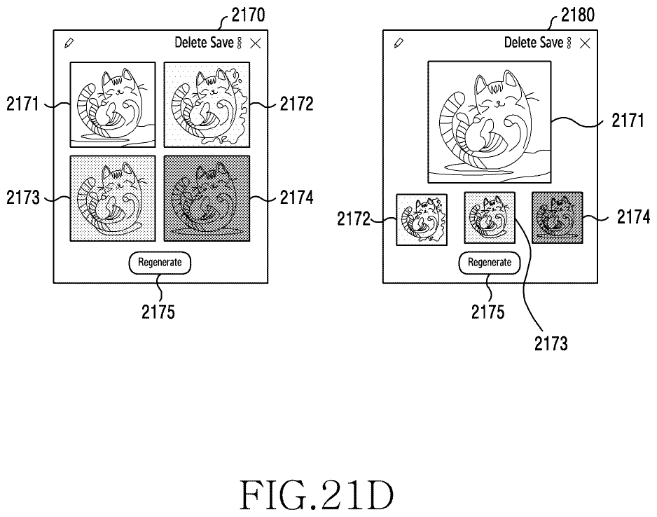

FIGS. 21A, 21B, 21C, and 21D illustrate examples of user interfaces to explain a process (e.g., operation 460 of FIG. 4, or operation 670 of FIG. 6) of displaying an image in the electronic device 200, according to an embodiment.

Referring to FIG. 21A, the electronic device 200 may display a first screen 2110. A drawing 2111 inputted by a user and a first image 2112 generated in response to the drawing 2111 may be displayed on the first screen 2110. For example, the first image 2112 may be generated (or acquired) based on at least one of the drawing 2111, description information on the drawing 2111, a similarity or an image style.

Referring to FIG. 21B, the electronic device 200 may display a first screen 2120 and/or a second screen 2130. For example, the electronic device 200 may display the first screen 2120 related to a first image 2121 generated in response to a drawing. When a user input (e.g., a touch) occurs on the first image 2121, the electronic device 200 may change the first screen 2120 to the second screen 2130. The second screen 2130 may be a screen that temporarily displays a second image 2131 in which the drawing overlaps the first image 2121. The electronic device 200 may change the second screen 2130 back to the first screen 2120 when a predefined time (e.g., 10 seconds) elapses or a user input (e.g., a touch) occurs on the second image 2131.

Referring to FIG. 21C, the electronic device 200 may generate (or acquire) a plurality of images (e.g., a first image 2151, and a second image 2152) corresponding to one drawing 2141 by using an AI model (e.g., the second AI model 320). The electronic device 200 may display screens (e.g., a second screen 2150, a third screen 2160) on the plurality of images 2151 and 2161, respectively.

According to an embodiment, the electronic device 200 may acquire the plurality of images 2151 and 2161 corresponding to the drawing 2141 of the user, and may sequentially display (or display or highlight with a higher priority) the plurality of images 2151 and 2161 starting from the image that has a smallest difference (or is closer to) from the drawing 2141.

According to an embodiment, the electronic device 200 may alternately display the first screen 2140, the second screen 2150, and the third screen 2160 in response to a user input (e.g., a swipe input). The first screen 2140 may be a screen including the drawing 2141 inputted by the user. The second screen 2150 may be a screen including the first image 2151 generated in response to the drawing 2141. The third screen 2160 may be a screen including the second image 2161 generated in response to the drawing 2141.

According to an embodiment, when a swipe input in a first direction (e.g., a leftward direction) occurs while the second screen 2150 on the first image 2151 is being displayed, the second screen 2150 on the first image 2151 may be changed to the third screen 2160 on the second image 2161. When a swipe input in a second direction (e.g., a rightward direction) occurs while the third screen 2160 on the second image 2161 is being displayed, the third screen 2160 on the second image 2161 may be changed to the second screen 2150 on the first image 2151.

According to an embodiment, the first screen 2140, the second screen 2150, or the third screen 2160 may include a plurality of image regeneration buttons (e.g., a first image regeneration button 2142, a second image regeneration button 2152, and a third image regeneration button 2162). The plurality of image regeneration buttons 2142 to 2162 may be for generating a new image corresponding to the drawing 2141.

For example, in a state in which one of the drawing 2141, the first image 2151, and the second image 2161 is displayed, the electronic device 200 may detect a user input (e.g., a touch) on the plurality of image regeneration button 2141 to 2162. The electronic device 200 may generate and/or display at least one third image in response to the user input. The first image 2151 and the second image 2161 may be previous images generated in response to the drawing 2141. The at least one third image may be a new image that is generated in response to the drawing 2141.

For example, the first image 2151 and the second image 2161 may be generated based on at least a portion of the drawing 2141, description information on the drawing 2141, a similarity, an image style, a skill level of the drawing, or transparency of a drawing area.

For example, the at least one third image may be generated based on the drawing 2141 and/or the previous images (e.g., the first image 2151, and the second image 2161) generated in response to the drawing 2141. For example, the at least one third image may be generated based on at least some of the drawing 2141, description information on the drawing 2141, a similarity, an image style, a skill level of the drawing, transparency of a drawing area, or the previous images (e.g., the first image 2151, and the second image 2161) that may be generated in response to the drawing 2111.

Referring to FIG. 21D, the electronic device 200 may receive a plurality of images of multiple versions on one drawing from the second AI model 320. The electronic device 200 may display the plurality of images within one screen.

For example, the plurality of images may be images of different styles corresponding to one drawing. For example, the electronic device 200 may display a first screen 2170 and/or a second screen 2180. The first screen 2170 may be a screen that displays a plurality of images (e.g., a first image 2171, a second image 2172, a third image 2173, and a fourth image 2174) of different styles in a listing method. The second screen 2180 may be a screen that preferentially displays a first image 2171 of a style selected by the user (e.g., displays in a first size), and displays second images (e.g., the second image 2172, the third image 2173, and the fourth image 2174) of other styles in a thumbnail form (e.g., displays in a second size smaller than the first size).

For example, the electronic device 200 may receive the plurality of images 2171 to 2174 corresponding to the drawing, and may sequentially display the plurality of images 2171 to 2174 starting from the image that has a smallest difference (or close to in distance) from the drawing (or display or highlight with a high priority).

The first screen 2170 and the second screen 2180 may include an image regeneration button 2175. The image regeneration button 2175 may be for generating a new image corresponding to the drawing.

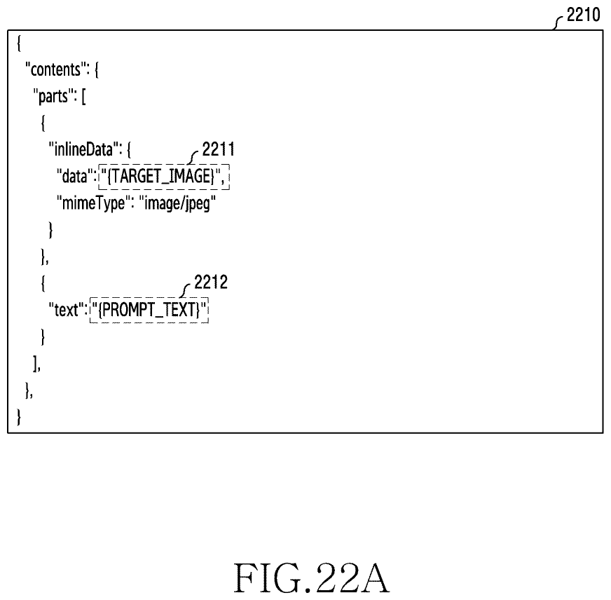

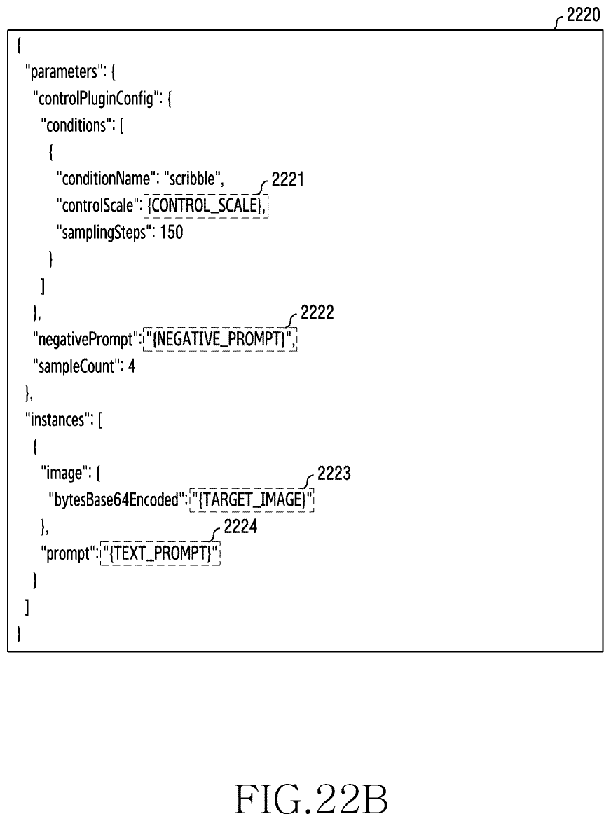

FIG. 22A illustrates an example of a first input prompt for requesting descriptions on a drawing, according to an embodiment.

Referring to FIG. 22A, the first input prompt for requesting a description on a drawing (e.g., the first input prompt in operation 630 shown in FIG. 6) may include a first text prompt 2210 of a predefined format (e.g., a JSON format). The first text prompt 2210 may include a first portion 2211 and/or a second portion 2212.

The first portion 2211 may be a portion indicating image data (string data of a base 64 type transformed from a drawing) on the drawing. The second portion 2212 may be a portion indicating description information (e.g., one or more natural language sentences depicting an object within a drawing) on the drawing.

FIG. 22B illustrates an example of a second input prompt for requesting generation of an image, according to an embodiment.

Referring to FIG. 22B, the second input prompt (e.g., the second input prompt in operation 650 shown in FIG. 6) for requesting generation of an image corresponding to a drawing may include a second text prompt 2220 of a predefined format (e.g., a JSON format). The second text prompt 2220 may include a first portion 2221, a second portion 2222, a third portion 2223, and/or a fourth portion 2224.

According to an embodiment, the second input prompt may include description information on the drawing.

The first portion 2221 may be a portion indicating a size attribute (e.g., at least one of a size, an aspect ratio, or a resolution) of an image to be generated.

The second portion 2222 may be a portion indicating a negative prompt. For example, the negative prompt may be for indicating one or more words and/or sentences to be filtered from the description information on the drawing.

The third portion 2223 may be a portion indicating image data on the drawing (string data of a base 64 type transformed from the drawing).

The fourth portion 2224 may be a portion indicating the description information on the drawing, and may include one or more natural language sentences related to the drawing and/or an object within the drawing.

According to an embodiment, the second input prompt may include a similarity between the drawing and the image to be generated.

According to an embodiment, the second input prompt may include at least one of the drawing to be used for generating an image or image style information.

According to an embodiment, the second input prompt may include additional information to be used for generating the image.

According to an embodiment, the additional information may further include at least a portion of a reference text inputted by the user (e.g., a text inputted via an input window), a reference image (e.g., a background image displayed in a drawing area, a captured image on a background application execution screen), form factor information of the electronic device 200, or form factor information of an external electronic device (e.g., a first external electronic device 2610, a second external electronic device 2620 of FIG. 26) connected with the electronic device 200 via short-range wireless communication.

According to an embodiment, the additional information may include at least one of user contents (e.g., a sketch drawn by the user in the past, a photo, a painting, an image, a video, a document) stored in the memory 230 or registered at a user account. When the additional information is used for generating an image, an image having continuity with the previous sketch or the user content, for example, an image including an object similar to an object in the previous sketch or the user content may be generated.

According to an embodiment, the additional information may include at least one of position information of the electronic device 200 (e.g., a place where the user is positioned) or application use information of the electronic device 200 (e.g., a previous conversation content of a chatting application that the user used before starting the drawing). When the additional information is used for generating the image, an image appropriate for situations of the user may be generated.

FIG. 23A illustrates an example of a hardware configuration of the electronic device 200, according to an embodiment.

According to an embodiment, the electronic device 200 may be an electronic device 2300 of a fixed form factor type (e.g., a smartphone, a tablet personal computer (PC)).

Referring to FIG. 23A, the electronic device 2300 may include a display 2310. The display 2310 of the electronic device 2300 may correspond to the display module 160 of FIG. 1 or the touch screen display 210 of FIG. 2.

In an embodiment, the display 2310 may include a display panel 2312, a touch panel 2311, and a digitizer module 2313. The touch panel 2311 may be positioned on a top surface of the display panel 2312 to detect a touch input of a capacitance method. The digitizer module 2313 may be positioned on a bottom surface of the display panel 2312 to detect a pen input of an electro-magnetic resonance (EMR) method.

According to an embodiment, an electronic pen 2330 may be used as an input tool. The electronic pen 2330 may correspond to the electronic pen 500 of FIG. 5. The electronic device 2300 may detect a touch input by the electronic pen 2330 via the display 2310.

According to an embodiment, the electronic device 2300 may include a structure to allow the electronic pen 2330 to be inserted. The electronic device 2300 may include a housing 2320. A hole 2321 may be formed on a portion of the housing 2320, for example, a portion of a side surface of the housing 2320. The electronic pen 2330 may be designed to be received in the hole 2321 in the housing 2320 of the electronic device 2300. An inner space that is a receiving space connected with the hole 2321 may be formed on the housing 2320. The electronic pen 2330 may be inserted into the inner space of the hole 2321 and may be stably attachable to or detachable from the inner space.

According to an embodiment, the electronic pen 2330 may be configured to have a magnetic attaching/detaching function. In this case, a structure (e.g., the hole 2321) for inserting/removing the electronic pen 2330 into/or from the housing 2320 may be omitted. The electronic pen 2330 may be fixed to a magnet portion formed on a side surface of the housing 2320, or may be easily removed when necessary.

FIG. 23B is a block diagram of the electronic pen 2330 that may be an input means, according to an embodiment.

Referring to FIG. 23B, as an input means, the electronic pen 2330 may include memory 2331, a communication circuit 2332, a processor 2333, a resonance circuit 2334, and a trigger circuit 2335. According to an embodiment, the processor 2333 may be electrically connected with the memory 2331, the communication circuit 2332, the resonance circuit 2334 and/or the trigger circuit 2335. However, the configuration of the electronic pen 2330 is not limited to the configuration illustrated in FIG. 23B, and the electronic pen 2330 may further include components in addition to the components illustrated or may include less components.

According to an embodiment, the memory 2331 of the electronic pen 2330 may store information related to operations of the electronic pen 2330. For example, the information may include information for communication with the electronic device 2300 and frequency information related to input operations of the electronic pen 2330. The memory 2331, according to an embodiment, may store a communication stack of the communication circuit 2332. Depending on implementation, the communication circuit 2332 and/or the processor 2333 may include a dedicated memory.

According to an embodiment, the communication circuit 2332 of the electronic pen 2330 may be configured to perform a wireless communication function between the electronic pen 2330 and a communication module (e.g., the communication circuit 240 of FIG. 2) of the electronic device 2300. According to an embodiment, the communication circuit 2332 may transmit state information of the electronic pen 2330, input information and/or information associated with a position to the electronic device 2300 by using a short-range communication method. For example, the communication circuit 2332 may transmit, to the electronic device 2300, orientation information (e.g., motion sensor data) of the electronic pen 2330 acquired via the trigger circuit 2335, audio information inputted via a microphone, information of a remaining capacity of a battery, and/or information on a state of a button (e.g., an on/off button) provided on the electronic pen 2330. According to an embodiment, the short-range communication method may include at least one of Bluetooth™, Bluetooth™ low energy (BLE), near field communication (NFC), Wi-Fi direct or IrDA, but is not limited thereto.

According to an embodiment, the processor 2333 of the electronic pen 2330 may be configured to collect various data and to compute a target output value. According to an embodiment, the processor 2333 may support various operations based on at least a portion of a user input. For example, the processor 2333 may include a generic processor configured to execute a customized hardware module or software (e.g., an application). The processor 2333 may include, for example, one of hardware, software or firmware or a combination of two (2) or more of these.

According to an embodiment, the processor 2333 of the electronic pen 2330 may be set to transmit, to the electronic device 2300 via the communication circuit 2332, information on a pressing state of a button, sensing information obtained by a sensor, and/or information computed based on sensing information (e.g., information associated with a position of the electronic pen 233).

According to an embodiment, the resonance circuit 2334 of the electronic pen 2330 may resonate based on an electromagnetic field signal generated from the digitizer module 2313 of the electronic device 2300, and may emit an EMR input signal by resonance. The electronic device 2300 may identify a position of the electronic pen 2330 by using the EMR input signal. For example, the electronic device 2300 may identify the position of the electronic pen 2330, based on a magnitude of an induced electromagnetic force (e.g., an output current) generated in response to the EMR input signal in each of a plurality of channels (e.g., a plurality of loop coils) in the digitizer module 2313.

In above explanation, it is illustrated that the electronic device 2300 and the electronic pen 2330 operate based on the EMR method, but this is merely an example and the operating method of the electronic pen 2330 is not limited thereto. For example, the electronic pen 2330 may generate a signal that is based on an electric field, based on an electrically coupled resonance (ECR) method. The resonance circuit 2334 of the electronic pen 2330 may resonate by the electric field. The electronic device 2300 may identify an electric potential in a plurality of channels (e.g., electrodes) by the resonance in the electronic pen 2330, and may identify the position of the electronic pen 2330 based on the electric potential. In another example, the electronic pen 2330 may be implemented in an active electrostatic (AES) method. In still another example, the electronic device 2300 may detect the electronic pen 2330 based on a change in capacitance associated with at least one electrode of the touch panel 2311. In this case, the resonance circuit 2334 may not be included in the electronic pen 2330.

According to an embodiment, the resonance circuit 2334 of the electronic pen 2330 may include a coil (or an inductor and/or a capacitor). The resonance circuit 2334 may resonate based on an electric field and/or a magnetic field inputted. When the electronic pen 2330 transmits a signal by the EMR method, the electronic pen 2330 may generate a signal including a resonance frequency, based on an electromagnetic field generated from an inductive panel of the electronic device 2300. When the electronic pen 2330 transmits a signal by the AES method, the electronic pen 2330 may generate a signal by using capacity coupling with the electronic device 2300. When the electronic pen 2330 transmits a signal by the ECR method, the electronic pen 2330 may generate a signal including a resonance frequency based on an electric field generated from a capacitive device of the electronic device 2300.

According to an embodiment, the resonance circuit 2334 of the electronic pen 2330 may be used for changing a magnitude of an electromagnetic field or a frequency according to a manipulation state of the user. For example, the resonance circuit 2334 may provide various frequencies for recognizing a hovering input, a drawing input, a button input or an erasing input. For example, the resonance circuit 2334 may provide various resonance frequencies according to a connection combination of a plurality of capacitors, or may provide various resonance frequencies based on a variable inductor and/or a variable capacitor.

According to an embodiment, the trigger circuit 2335 of the electronic pen 2330 may include at least one button or sensor circuit. According to an embodiment, the processor 2333 may identify a button input method (e.g., a touch, a press) or type of the electronic pen 2330. According to an embodiment, the trigger circuit 2335 may transmit a trigger signal to the electronic device 2300 connected wirelessly by using an input signal of the button.

In an embodiment, the electronic pen 2330 may be connected with the electronic device 2300 via short-range wireless communication. For example, the electronic device 2300 and the electronic pen 2330 may be connected via short-range communication by using at least one of Bluetooth™ communication, BLE communication, and/or Wi-Fi communication. In this case, the electronic pen 2330 may be used for the electronic device 2300 to generate a user input. For example, the electronic pen 2330 may come into contact with the display 2310 of the electronic device 2300 or approach within a reference distance from the electronic device 2300 (non-contact) to generate an input for the electronic device 2300.

In an embodiment, even when there is no short-range wireless communication connection between the electronic pen 2330 and the electronic device 2300, the electronic device 2300 may detect a touch input by the electronic pen 2330 via the display 2310 or may provide a drawing function using the electronic pen 2330.

FIG. 24 illustrates an example of a hardware configuration of a foldable electronic device 2400, according to an embodiment.

According to an embodiment, the electronic device 200 may be an electronic device of a flexible form factor type where the form factor is deformable. For example, the electronic device 200 may be the foldable electronic device 2400 of FIG. 24.

Referring to FIG. 24, reference numeral 2401 shows a first state in which the foldable electronic device 2400 is unfolded. The first state may be a fully unfolded state in which the foldable electronic device 2400 is fully unfolded (e.g., a state in which a folding angle is substantially 180 degrees). Reference numeral 2402 shows a second state in which the foldable electronic device 2400 is folded. The second state may be a fully folded state in which the foldable electronic device 2400 is fully folded (e.g., a state in which the folding angle may be substantially zero (0) degree).

Referring to FIG. 24, the foldable electronic device 2400 may include a foldable housing 2420 and a display 2410 disposed in a space formed by the foldable housing 2420. The display 2410 of the foldable electronic device 2400 may correspond to the display module 160 of FIG. 1 or the touch screen display 210 of FIG. 2.

According to an embodiment, the foldable housing 2420 may include a first housing 2421 and a second housing 2422. The first housing 2421 and/or the second housing 2422 may form at least a portion of the exterior of the foldable electronic device 2400.

According to an embodiment, the display 2410 may include a first display 2411 (e.g., a flexible display, a front surface display, a main display) and a second display 2412 (e.g., a rear surface display, a sub-display).

According to an embodiment, the first housing 2421 and the second housing 2422 may be connected by a hinge (not shown), and may be rotated about a folding axis A relative to each other by the hinge. Accordingly, the first housing 2421 and/or the second housing 2422 of the foldable electronic device 2400 may be folded or unfolded with reference to the folding axis A. In addition, the folding angle of the foldable electronic device 2400 and/or the folding state of the foldable electronic device 2400 (e.g., the first state of reference numeral 2401, the second state of reference numeral 2402, or an intermediate state between the first state and the second state) may be changed.

In an embodiment, a surface to which the first display 2411 of the display 2410 is visually exposed is defined as a front surface of the foldable electronic device 2400. In addition, the opposite surface of the front surface is defined as a rear surface of the foldable electronic device 2400. In addition, a surface that encloses at least a portion of the space between the front surface and the rear surface is defined as a side surface of the foldable electronic device 2400.

According to an embodiment, when the folding state of the foldable electronic device 2400 is the first state 2401 (fully unfolded state), the first display 2411 may be visually exposed through the front surface of the foldable electronic device 2400 or may be activated. When the folding state of the foldable electronic device 2400 is the second state 2402 (fully folded state), the first display 2411 may not be exposed to the outside of the foldable electronic device 2400 and the second display 2412 may be visually exposed through the rear surface of the foldable electronic device 2400.

According to an embodiment, the first housing 2421 may provide a relative motion to the second housing 2422, and the second housing 2422 may provide a relative motion to the first housing 2421.

According to an embodiment, the first housing 2421 may rotate relative to the second housing 2422 by using the hinge. Accordingly, the foldable electronic device 2400 may change to the first state 2401 or the second state 2402.

According to an embodiment, the first housing 2421 and the second housing 2422 may be disposed on both sides with reference to the folding axis A, and may have a substantially symmetric shape with respect to the folding axis A.

According to an embodiment, the first housing 2421 and the second housing 2422 may have an angle or a distance therebetween changed according to a folding state of the foldable electronic device 2400. The angle between the first housing 2421 and the second housing 2422 may be changed according to whether the folding state of the foldable electronic device 2400 is the first state 2401 (fully unfolded state), the second state 2402 (fully folded state), or the intermediate state between the first state 2401 and the second state 2402. The angle between the first housing 2421 and the second housing 2422 may be interpreted as a folding angle of the foldable electronic device 2400.

According to an embodiment, the display 2410 of the foldable electronic device 2400 may include the first display 2411 (e.g., a flexible display, a front surface display, a main display). According to an embodiment, the first display 2411 may have a structure that allows at least some regions to be deformed into a flat or curved surface. For example, the first display 2411 may be formed to be deformable in response to the relative motion of the second housing 2422 to the first housing 2421.

According to an embodiment, the display 2410 of the foldable electronic device 2400 may include the second display 2412 (e.g., a rear surface display, a sub-display). The second display 2412 may be disposed to face a different direction from the first display 2411. For example, the first display 2411 may be visually exposed through the front surface of the foldable electronic device 2400, and the second display 2412 may be visually exposed through the rear surface of the foldable electronic device 2400.

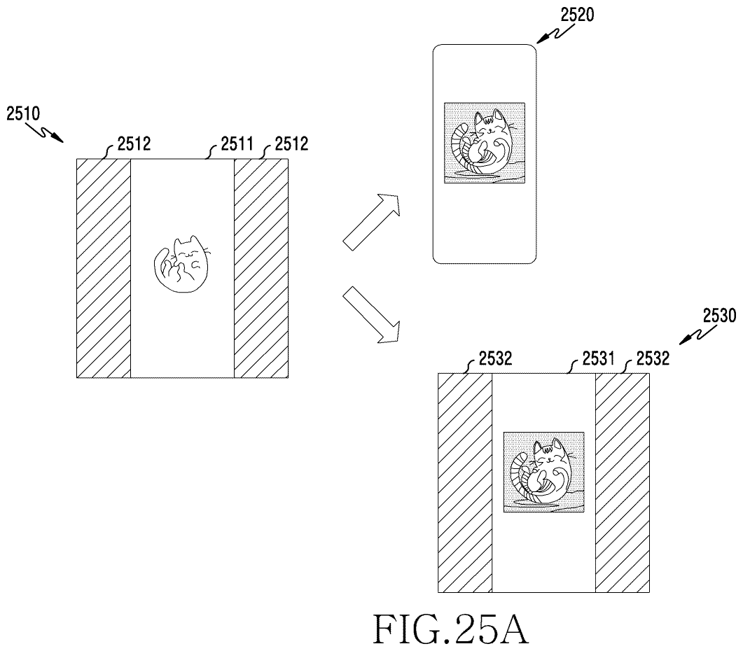

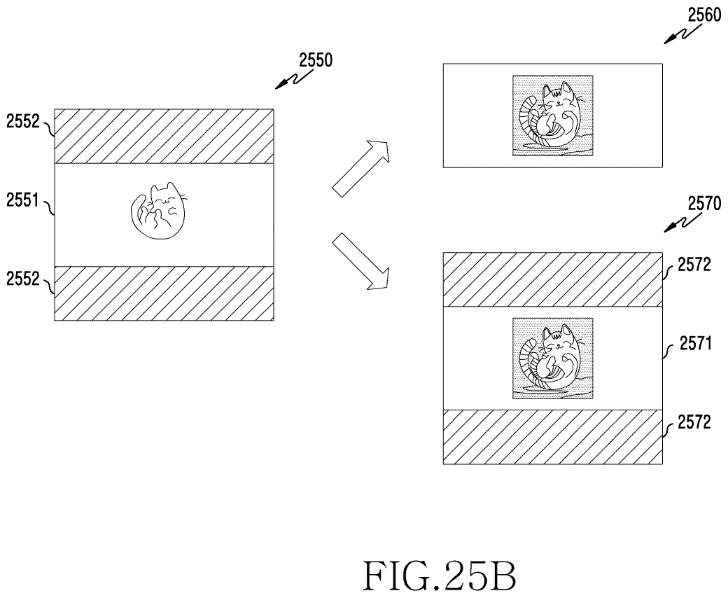

FIGS. 25A and 25B illustrate examples of a drawing and an image displayed on the electronic device 200, according to an embodiment.

According to an embodiment, a drawing inputted by a user and an image generated in response to the drawing may have different size attributes (e.g., at least one of a size, an aspect ratio or a resolution). In this case, the electronic device 200 may adjust the size attribute of the drawing or may adjust the size attribute of the image generated in response to the drawing.

According to an embodiment, the electronic device 200 may be the foldable electronic device 2400 of FIG. 24. The folding state of the foldable electronic device 2400 may be changed. As the folding state of the foldable electronic device 2400 is changed, the size of a display area may be changed. The size of the display area may refer to a size of a display area that is used (or activated) to display a user's drawing and/or an image.

For example, when the foldable electronic device 2400 is in the first state 2401 (fully unfolded state) of FIG. 24, the first display 2411 may be visually exposed through the front surface of the foldable electronic device 2400 and may be activated. In this case, the size of the display area of the foldable electronic device 2400 may correspond to a first size that may be the size of the first display 2411.

For example, when the foldable electronic device 2400 is in the second state 2402 (fully folded state) of FIG. 24, the second display 2412 may be visually exposed through the rear surface of the foldable electronic device 2400 and may be activated. In the second state 2402 (fully folded state), the first display 2411 may not visually be exposed to the outside of the foldable electronic device 2400. In this case, the size of the display area of the foldable electronic device 2400 may correspond to a second size that may be the size of the second display 2412. The second size may have a value (e.g., less than or equal to 50%) that is smaller than the first size.

In the case of the foldable electronic device 2400, the size of the drawing actually drawn by the user may be changeable. For example, according to the folding state of the foldable electronic device 2400, the size attribute of the drawing may have a value (e.g., an aspect ratio of 16:9) corresponding to the size of the first display 2411 or the size of the second display 2412. On the other hand, an image generated in response to the drawing may have a predefined size attribute (e.g., an aspect ratio of 1:1). Thus, the size attribute of the drawing and the size attribute of the image may be different from each other.

According to an embodiment, the foldable electronic device 2400 may adjust the size attribute of the drawing and/or the image to match the size attributes of the drawing and the image each other.

Referring to FIG. 25A, when the foldable electronic device 2400 is in a first situation where the folding state of the foldable electronic device 2400 is the first state 2401, the first display 2411 is activated, and the display mode of the first display 2411 is a portrait mode, the user may input a drawing 2511 via the first display 2411 of the portrait mode. The drawing 2511 may have a first size attribute (e.g., an aspect ratio of 3:4). The foldable electronic device 2400 may generate a source image 2510 in which left and right padding areas 2512 are added to the drawing 2511. The source image 2510 may have a first size attribute (e.g., an aspect ratio of 1:1). The foldable electronic device 2400 may acquire a first image 2520 and a second image 2530 by using the source image 2510 having the first size attribute (e.g., the aspect ratio of 1:1). The first image 2520 may have the same size attribute (e.g., the aspect ratio of 3:4) as the drawing 2511. The second image 2530 may be an image in which left and right padding areas 2532 are added to a basic area 2531 corresponding to the first image 2520, and may have the same size attribute (e.g., the aspect ratio of 1:1) as the source image 2510. The foldable electronic device 2400 may acquire the first image 2520 and the second image 2530 that may have different size attributes from an AI model (e.g., the second AI model 320 of FIG. 3). The foldable electronic device 2400 may select the first image 2520 out of the first image 2520 and the second image 2530, based on the first situation (e.g., a current folding state and/or a portrait mode). The foldable electronic device 2400 may display the selected first image 2520.

Referring to FIG. 25B, when the folding state of the foldable electronic device 2400 is the first state 2401, the first display 2411 is activated, and the display mode of the first display 2411 is a landscape mode, the user may input a drawing 2551 via the first display 2411 of the landscape mode. The drawing 2551 may have a first size attribute (e.g., an aspect ratio of 4:3). The foldable electronic device 2400 may generate a source image 2550 in which upper and lower padding areas 2552 are added to the drawing 2551. The source image 2550 may have a first size attribute (e.g., an aspect ratio of 1:1). The foldable electronic device 2400 may acquire a first image 2560 and a second image 2570 by using the source image 2550 having the first size attribute (e.g., the aspect ratio of 1:1). The first image 2560 may have the same size attribute (e.g., the aspect ratio of 4:3) as the drawing 2551. The second image 2570 may be an image in which upper and lower padding areas 2572 are added to a basic area 2571 corresponding to the first image 2560, and may have the same size attribute (e.g., the aspect ratio of 1:1) as the source image 2550. The foldable electronic device 2400 may acquire the first image 2560 and the second image 2570 that may have different size attributes from an AI model (e.g., the second AI model 320 of FIG. 3). The foldable electronic device 2400 may select the first image 2560 out of the first image 2560 and the second image 2570, based on a second situation (e.g., a current folding state and/or a landscape mode). The foldable electronic device 2400 may display the selected first image 2560.

According to an embodiment, the foldable electronic device 2400 may acquire a plurality of images corresponding to form factor information by providing the form factor information of the foldable electronic device 2400 to an AI model (e.g., the second AI model 320 of FIG. 3) along with a drawing.

According to an embodiment, the form factor information may include device information (e.g., at least one of a device type, a model name, a display shape (e.g., a rectangle, a circle) or display sizes depending on a change in the folding state) of the foldable electronic device 2400. For example, the plurality of images may include an image corresponding to a first size that may be the size of the first display 2411, and an image corresponding to a second size that may be the size of the second display 2412. The foldable electronic device 2400 may display at least one of the plurality of images acquired via the first display 2411 or the second display 1412.

The electronic device 200, according to an embodiment, may be a rollable (slidable) electronic device although it is not illustrated. According to an embodiment, the rollable electronic device may acquire a plurality of images corresponding to form factor information by providing the form factor information of the rollable electronic device (e.g., at least one of a device type, a model name, a display shape (e.g., a rectangle, a circle) or displays sizes depending on a change in the rolling (or sliding) state) to an AI model (e.g., the second AI model 320 of FIG. 3) along with the drawing.

The display size of the rollable (or slidable) electronic device may be changeable according to a rolling (or sliding) operation. For example, the display size in a first state (e.g., a maximum reduction state) may be a first size. The display size in a second state (e.g., a maximum extension state) may be a second size that may be larger than the first size. For example, in the first state, the rollable electronic device may receive a user input of selecting an interface element (e.g., an image generation button) for requesting generation of an image corresponding to a drawing. When a rolling (or sliding) operation to change from the first state to the second state is detected after the rollable electronic device receives the user input, the rollable electronic device may transmit the second size that may be the display size in the second state to an AI model (e.g., the second AI model 320 of FIG. 3), thereby acquiring and/or displaying an image generated in response to the second size. As described above, when the rolling state is changed in the middle of performing the image providing function, an image appropriate for the changed display size may be provided.

FIG. 26 is a view illustrating an external electronic device (e.g., a first external electronic device 2610, and a second external electronic device 2620) (or a target electronic device) that may interlock with the electronic device 200, according to an embodiment.

According to an embodiment, the electronic device 200 may be the electronic device 2300 of FIG. 23A.

Referring to FIG. 26, the electronic device 2300 may provide an image by interlocking with a first external electronic device 2610 (e.g., an extended reality display device such as a head mounted display (HMD)) and/or a second external electronic device 2620 (e.g., a wearable device such as a smart watch).

According to an embodiment, the electronic device 2300 may be in a state in which the electronic device 2300 is connected with the first external electronic device 2610 and/or the second external electronic device 2620 by short-range wireless communication (e.g., Bluetooth™, Wi-Fi, or the like) via a communication circuit (e.g., the communication circuit 240 of FIG. 2).

According to an embodiment, the electronic device 2300 may receive a drawing 2601 that may be inputted by a user via the display 2310. The electronic device 2300 may provide form factor information of the first external electronic device 2610 and/or the second external electronic device 2620 to an AI model (e.g., the second AI model 320 of FIG. 3) along with the drawing 2601, thereby acquiring at least one image (e.g., a first image 2602 and/or a second image 2603) corresponding to the form factor information.

The form factor information may include device information of the first external electronic device 2610 (e.g., at least one of a device type, a model name, a display shape (e.g., a rectangle, a circle) or a size of a first external display 2611). The form factor information may include device information of the second external electronic device 2620 (e.g., at least one of a device type, a model name, or a size of a second external display 2621).

The image acquired from the AI model may include the first image 2602 corresponding to the size of the first external display 2611 and/or the second image 2603 corresponding to the size of the second external display 2621.

The electronic device 2300 may transmit the first image 2602 acquired from the AI model to the first external electronic device 2610 via the communication circuit (e.g., the communication circuit 240 of FIG. 2), such that the first image 2602 may be displayed through the first external display 2611 of the first external electronic device 2610. The electronic device 2300 may transmit the second image 2603 acquired from the AI model to the second external electronic device 2620, such that the second image 2603 may be displayed through the second external display 2621 of the second external electronic device 2620.

According to an embodiment, the electronic device 2300 may provide form factor information of an external electronic device (e.g., the first external electronic device 2610 and/or the second external electronic device 2620 of FIG. 26) that is registered at a user account of the electronic device 2300 and has been connected with the electronic device 2300 (has the history of having been connected) to an AI model (e.g., the second AI model 320 of FIG. 3) along with the drawing 2601. By doing so, the electronic device 2300 may acquire at least one image (e.g., the first image 2602 and/or the second image 2603) corresponding to the form factor information. Thereafter, the electronic device 2300 may connect short-range wireless communication (e.g., Bluetooth™, Wi-Fi, or the like) with the external electronic device via a communication circuit (e.g., the communication circuit 240 of FIG. 2). The electronic device 2300 may transmit the at least one image (e.g., the first image 2602 and/or the second image 2603) via the short-range wireless communication, thereby allowing the at least one image to be displayed through a display of the external electronic device (e.g., the first external display 2611 and/or the second external display 2612).

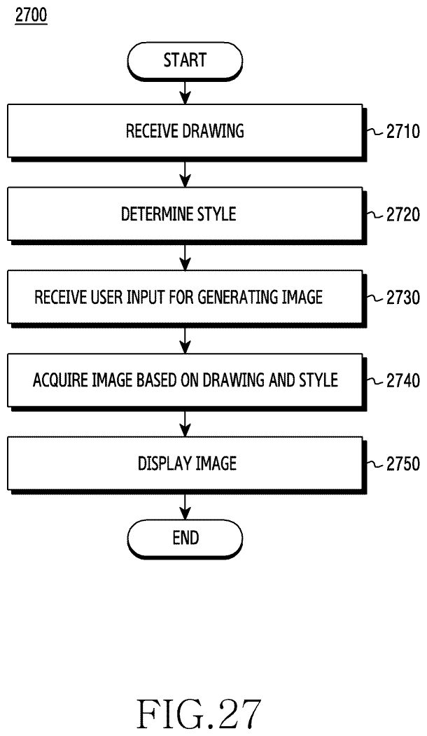

FIG. 27 is a flowchart illustrating an image providing method of the electronic device 200, according to an embodiment.

According to an embodiment, the electronic device 200 may generate an image corresponding to a drawing based on at least a portion of the user's drawing and style information of an image to be generated (image style information).

Referring to FIG. 27, the image providing method 2700 of the electronic device 200 may include operation 2710, operation 2720, operation 2730, operation 2740, and operation 2750. In an embodiment, some of the illustrated operations may be omitted, some operations may be integrated, the order of some operations may be changed, or other operations may be added.

According to an embodiment, at least some of the operations illustrated in FIG. 27 may correspond to operations of FIG. 4. For example, operation 2710 of FIG. 27 may correspond to operation 410 of FIG. 4. Operation 2730 of FIG. 27 may correspond to operation 420 of FIG. 4. Operation 2750 of FIG. 27 may correspond to operation 460 of FIG. 4. At least some of the operations illustrated in FIG. 27 may be performed by a combination with at least some of the operations of FIG. 4.

In operation 2710, the electronic device 200 (e.g., the processor 220) may receive (or detect) a drawing according to a first user input (e.g., a touch, a gesture, a stroke input, a painting input, a handwriting input) via the touch screen display 210.

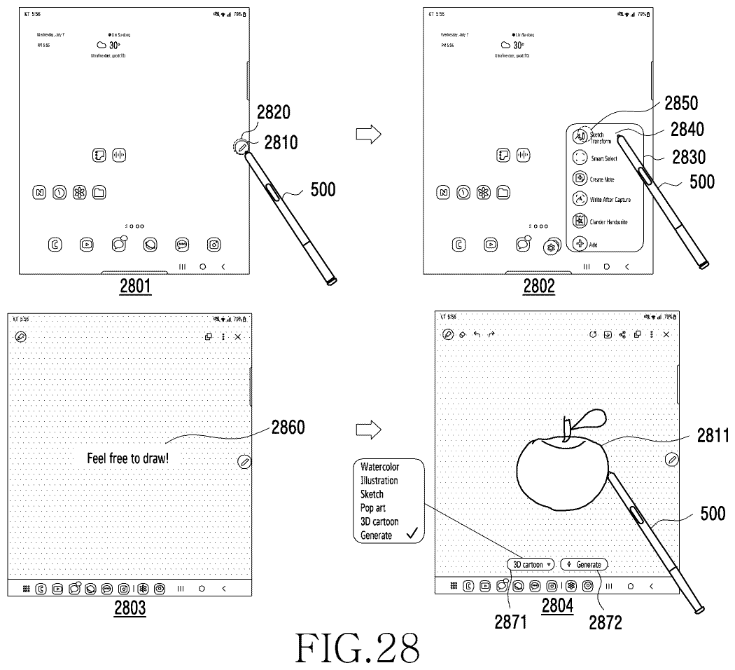

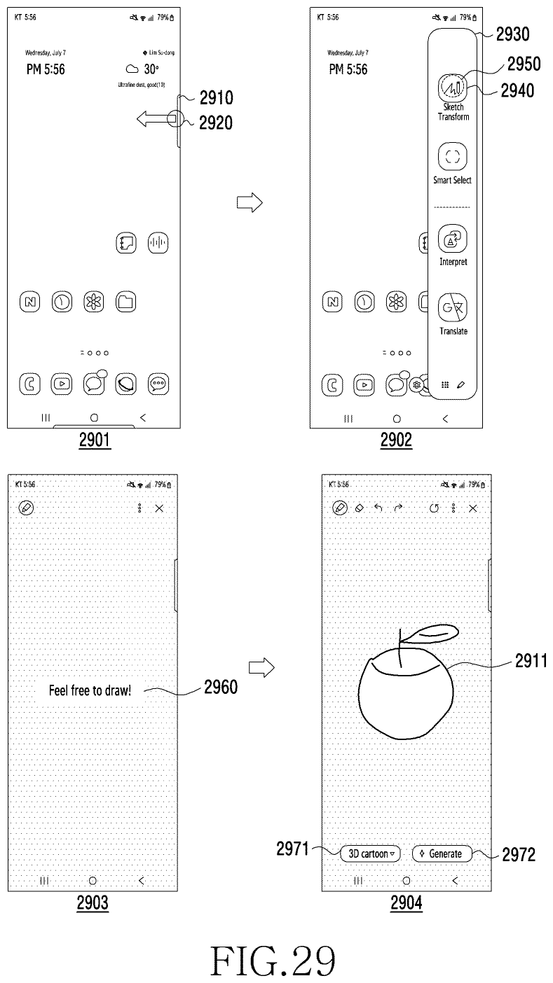

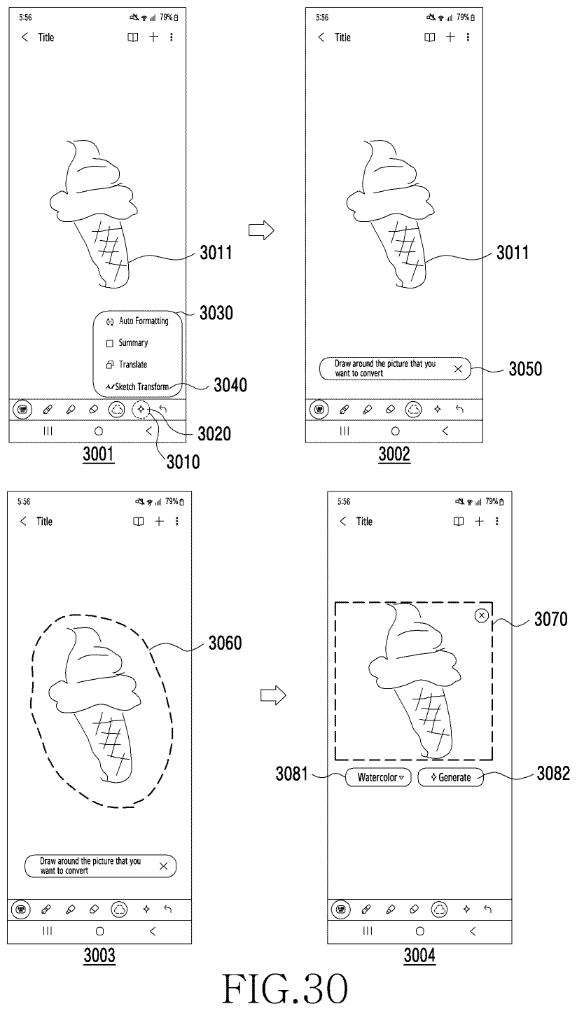

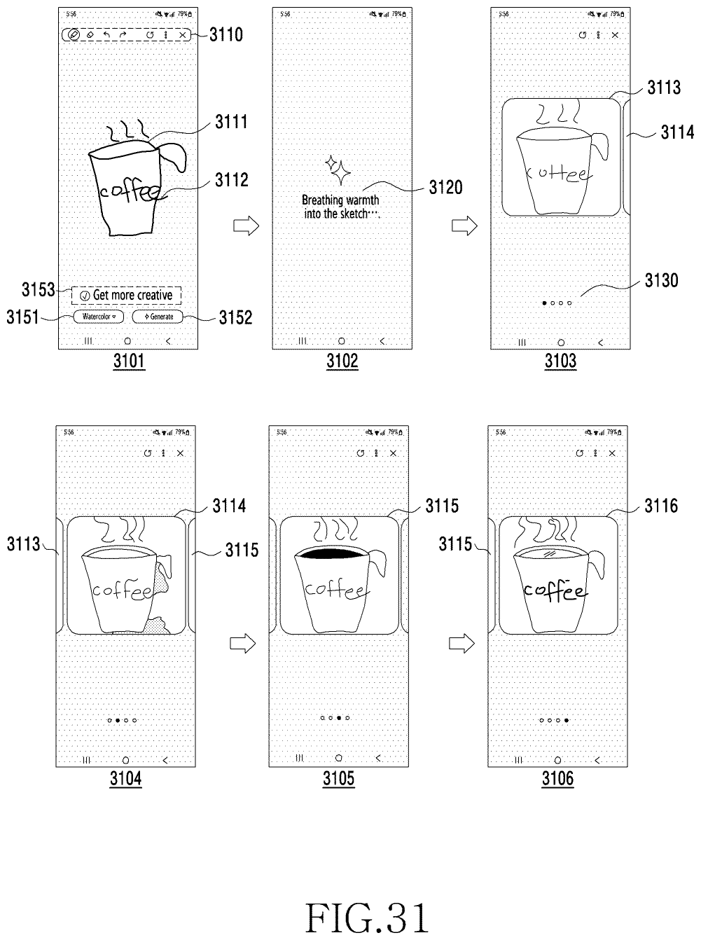

According to an embodiment, the electronic device 200 may display a user interface (e.g., a third screen 2803 of FIG. 28, a third screen 2903 of FIG. 29, a first screen 3001 of FIG. 30, a first screen 3101 of FIG. 31) for receiving a drawing on the touch screen display 210 in response to a triggering event occurring. For example, the triggering event may include at least one of an event in which a hovering input by an electronic device (e.g., the electronic pen 500 of FIG. 5) (e.g., a hovering input on a first screen 2801 of FIG. 28 by the electronic pen 500) is detected, an event in which a user input of selecting a predefined visual element (e.g., a sketch transform icon 2940 of FIG. 29) within an edge area of the touch screen display 210 is detected, and an event in which a user input of selecting a predefined visual element (e.g., a sketch transform menu 3040 of FIG. 30) within an application execution screen is detected. The electronic device 200 may receive a user's drawing via the user interface.

In operation 2720, the electronic device 200 (e.g., the processor 220) may determine (or identify) a style of an image to be generated (image style).

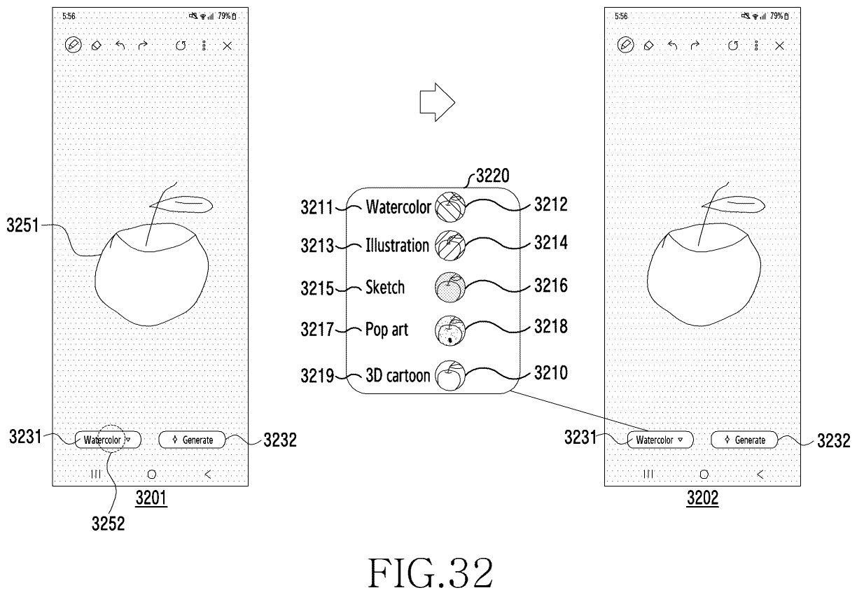

According to an embodiment, the electronic device 200 may display, on the touch screen display 210, a first interface element (e.g., a first interface element 2871 of FIG. 28, a first interface element 2971 of FIG. 29, a first interface element 3071 of FIG. 30, a first interface element 3151 of FIG. 31, a first interface element 3231 of FIG. 32) for selecting a style of the image to be generated from a plurality of predefined styles. The electronic device 200 may select one specific style (image style) from the plurality of predefined styles according to a user input on the first interface element.

In operation 2730, the electronic device 200 (e.g., the processor 220) may receive (or detect) a second user input for generating an image (e.g., a touch on an image generation button 2872 of FIG. 28, a touch on an image generation button 2972 of FIG. 29, a touch on an image generation button 3082 of FIG. 30, a touch on an image generation button 3152 of FIG. 31) via the touch screen display 210.

In operation 2740, the electronic device 200 (e.g., the processor 220) may acquire an image corresponding to the drawing, based on the drawing received through operation 2710 and the style determined through operation 2720.

According to an embodiment, the electronic device 200 may provide the user's drawing received through operation 2710 and the image style information (specific style information) determined through operation 2720 to an AI model (e.g., the first AI model 310 and/or the second AI model 320 of FIG. 3) in response to the second user input in operation 2730, thereby obtaining (or generating) an image of a specific style corresponding to the drawing.

In operation 2750, the electronic device 200 (e.g., the processor 220) may display the image acquired through operation 2740 via the touch screen display 210.

FIG. 28 illustrates examples of user interfaces to explain a process of receiving a drawing via the electronic pen 500 by the electronic device 200, according to an embodiment.

According to an embodiment, the electronic device 200 may perform an operation (e.g., operation 410 of FIG. 4) of receiving a user's drawing via a visual element (e.g., a floating button 2810) that may interlock with the electronic pen 500.

Referring to FIG. 28, the electronic device 200 may display user interfaces such as a first screen 2801, a second screen 2802, a third screen 2803, and a fourth screen 2804 via the touch screen display 210. The first screen 2801, the second screen 2802, the third screen 2803, and the fourth screen 2804 may be user interfaces for receiving a drawing.

The electronic device 200 may detect a hovering input of the electronic pen 500 on the first screen 2801 in the middle of displaying the first screen 2801 (e.g., a home screen) on the touch screen display 210. When the hovering input of the electronic pen 500 is detected, the electronic device 200 may display the floating button 2810 on the first screen 2801. The floating button 2810 may be a visual element (or a graphical element) that interlocks with the electronic pen 500.

The user may select the floating button 2810 by using the electronic pen 500. When a user input 2820 (e.g., a touch) of selecting the floating button 2810 is received, the electronic device 200 may display the second screen 2802.

The electronic device 200 may display a pop-up window 2830 on the second screen 2802. The pop-up window 2830 may include at least one visual element indicating a function that is selected and/or executed by the electronic pen 500.

At least one of the visual elements within the pop-up window 2830 may be related to an image providing function. For example, a sketch transform menu 2840 in the pop-up window 2830 may be a visual element related to the image providing function. The user may select the sketch transform menu 2840 by using the electronic pen 500. When a user input 2850 (e.g., a touch) of selecting the sketch transform menu 2840 is received, the electronic device 200 may display the third screen 2803.

A text 2860 (e.g., “Feel free to draw!”) that guides the user to input a drawing may be displayed on the third screen 2803.

The user may input a drawing 2811 into the third screen 2803 by using the electronic pen 500. The electronic device 200 may receive the drawing 2811 in response to the user input. When the drawing 2811 is received, the third screen 2803 may be converted into the fourth screen 2804. The fourth screen 2804 may include a first interface element 2871 for selecting a style of an image to be generated, and an image generation button 2872. For example, the first interface element 2871 may be for selecting any one style of watercolor, illustration, sketch, pop-art, 3D cartoon, no style, or random style.

The first interface element 2871 of FIG. 28 may correspond to the first interface element 721 of FIG. 7B. The image generation button 2872 of FIG. 28 may correspond to the image generation button 741 of FIG. 7C.

According to an embodiment, a menu (not shown) for loading a content (e.g., a photo, a painting, a still image, a video, a document) stored in the memory 230 or registered at a user account may further be displayed on the fourth screen 2804. The electronic device 200 may load a content desired by the user in response to a user input on the menu, and may use the content as a reference content (e.g., a reference image).

For example, the electronic device 200 may load a painting to be used as a reference content in response to a user input on the menu, and may display the painting. The user of the electronic device 200 may draw a sketch over the painting. For example, the electronic device 200 may transmit the painting to an AI model (e.g., the second AI model 320 of FIG. 3) as additional information to be referenced for the style of the image to be generated. The AI model may determine the style (e.g., watercolor, illustration) of the painting as the style of the image to be generated.

According to an embodiment, the fourth screen 2804 may further include an input window (not shown) through which a text to be used as additional information for generating the image is inputted. For example, the user may input a text to be used as additional information (e.g., “a painting of a cat”, “Draw a beach as a background.”, “Select XX as the breed”, a related link (URL), the title of a reference document (e.g., a paper name)) through the input window. The electronic device 200 may transmit the text to an AI model (e.g., the second AI model 320 of FIG. 3), thereby allowing the text to be used as additional information for generating an image.

According to an embodiment, the fourth screen 2804 may further include a menu (not shown) for determining characteristics of the image to be generated (e.g., at least one of a resolution, a size, a format (e.g., extension) or a type (e.g., a still image type, a slide show type, an animation type, a video type)). The characteristics of the image to be generated (e.g., at least one of the resolution, size, format or type) may be determined in response to a user input through the menu. The characteristics of the image to be generated may be automatically determined according to the style of the image.

According to an embodiment, the electronic device 200 may receive a drawing through a drawing area (an empty space) in which a content is not displayed.

According to an embodiment, the electronic device 200 may receive an input of a drawing that is drawn over the content in the middle of displaying the content in the drawing area. For example, the content that is being displayed may be a content (e.g., a sketch that the user drew in the past, a photo, a painting, an image, a video, a document) that is stored in the memory 230 of the electronic device 200 or registered at a user account. In this case, the electronic device 200 may transmit the content to an AI model (e.g., the second AI model 320 of FIG. 3) as additional information along with the drawing, such that the content is reflected on the generation of the image.

For example, the electronic device 200 may display an image on an external environment on an XR user interface (drawing area) of the touch screen display 210 in an extended reality (XR) environment provided by the electronic device 200, and may make a drawing over an image on the external environment. In this case, the electronic device 200 may transmit the image on the external environment to an AI model (e.g., the second AI model 320 of FIG. 3) as additional information along with the drawing, thereby allowing the image on the external environment to be reflected on the generation of the image corresponding to the drawing.

FIG. 29 illustrates examples of user interfaces to explain a process of receiving a drawing through an edge area by the electronic device 200, according to an embodiment.

According to an embodiment, the electronic device 200 may perform an operation (e.g., operation 410 of FIG. 4) of receiving a user's drawing through an edge area of the touch screen display 210.

Referring to FIG. 29, the electronic device 200 may display user interfaces such as a first screen 2901, a second screen 2902, a third screen 2903, and a fourth screen 2904 via the touch screen display 210. The first screen 2901, the second screen 2902, the third screen 2903, and the fourth screen 2904 may be user interfaces for receiving a drawing.

The electronic device 200 may display the first screen 2901 (e.g., a home screen) on the touch screen display 210. An edge panel handler 2910 may be displayed on an edge area of one side surface of the touch screen display 210. The edge panel handler 2910 may be a visual element (or a graphical element) for executing a shortcut function.

The electronic device 200 may display the second screen 2902 including an edge panel 2930 in response to a user input (e.g., a swipe gesture) 2920 on the edge area (or the edge panel handler 2910) of the touch screen display 210. The edge panel 2930 may include at least one visual element indicating an executable shortcut function.

At least one of the visual elements in the edge panel 2930 may be related to an image providing function. For example, a sketch transform icon 2940 in the edge panel 2930 may be a visual element related to the image providing function.

When a user input 2950 on the sketch transform icon 2940 is received, the electronic device 200 may display the third screen 2903.

A text (e.g., “Feel free to draw.”) 2960 may be displayed on the third screen 2903 to guide the user to input a drawing.

The electronic device 200 may receive a drawing 2911 in response to a user input. When the drawing 2911 is received, the third screen 2903 may be converted to the fourth screen 2904. The fourth screen 2904 may include a first interface element 2971 for selecting a style of an image to be generated, and an image generation button 2972.

The first interface element 2971 of FIG. 29 may correspond to the first interface element 721 of FIG. 7B. The image generation button 2972 of FIG. 29 may correspond to the image generation button 741 of FIG. 7C.

FIG. 30 illustrates example of user interfaces to explain a process of receiving a drawing via a predefined application by the electronic device 200, according to an embodiment.

According to an embodiment, the electronic device 200 may perform an operation (e.g., operation 410 of FIG. 4) of receiving a user's drawing by using a predefined application.

Referring to FIG. 30, the electronic device 200 may display user interfaces such as a first screen 3001, a second screen 3002, a third screen 3003, and a fourth screen 3004 via the touch screen display 210 while executing a predefined application (e.g., a note application). The first screen 3001, the second screen 3002, the third screen 3003, and the fourth screen 3004 may be user interfaces for receiving a drawing, and may be execution screens of the same application (e.g., a note application).

The electronic device 200 may display the first screen 3001 on the touch screen display 210. The electronic device 200 may receive a drawing 3011 in response to a user input on the first screen 3001. A generative AI icon 3010 may be displayed in a certain region in the first screen 3001.

The electronic device 200 may display a first pop-up window 3030 on the first screen 3001 in response to a user input 3020 (e.g., a touch) on the generative AI icon 3010. The first pop-up window 3030 may include at least one visual element indicating a function that is executable in association with the generative AI model.

At least one of the visual elements in the first pop-up window 3030 may be related to an image providing function. A sketch transform menu 3040 in the first pop-up window 3030 may be a visual element related to the image providing function.

When a user input on the sketch transform menu 3040 is received, the electronic device 200 may display the second screen 3002.

The second screen 3002 may display a second pop-up window 3050 including a text (e.g., “Draw around the picture that you want to convert.”) for guiding the user to select an area including the drawing 3011 in a predefined method to generate an image.

The electronic device 200 may receive a user input 3060 of selecting an area including the drawing 3011 (e.g., an area in a closed curve shape enclosing the drawing 3011) on the third screen 3003.

The electronic device 200 may select a drawing area 3070 in response to the user input 3060, and may display the fourth screen 3004 indicating the drawing area 3070. The fourth screen 3004 may include a first interface element 3081 for selecting a style of an image to be generated for the drawing area 3070, and an image generation button 3082.

The first interface element 3081 of FIG. 30 may correspond to the first interface element 721 of FIG. 7B. The image generation button 3082 of FIG. 30 may correspond to the image generation button 741 of FIG. 7C.

FIG. 31 illustrates examples of user interfaces to explain an image providing function of the electronic device 200, according to an embodiment.

Referring to FIG. 31, the electronic device 200 may display user interfaces such as a first screen 3101, a second screen 3102, a third screen 3103, a fourth screen 3104, a fifth screen 3105, and a sixth screen 3106 via the touch screen display 210.

The first screen 3101 may be a user interface for receiving a drawing and/or generating an image. The first screen 3101 may include a drawing area to receive a drawing from a user, and/or visual elements 3110 indicating functions executable in relation with the drawing. For example, the functions that are executable in relation with the drawing may include at least a portion of erasing the drawing, undoing/redoing, re-making a drawing, storing/sharing the drawing, transparency, minimizing, copying, setting or closing the drawing.

The first screen 3101 may include a first interface element 3151 to select a style of an image to be generated, a second interface element 3153 for selecting (or setting) a similarity, and an image generation button 3152.

According to an embodiment, the electronic device 200 may display drawings (e.g., a first drawing 3111, and a second drawing 3112) that the user makes with the electronic pen 500 (or finger) in real time. For example, the first and second drawings 3111 and 3112 may include a first drawing 3111 corresponding to a sketch (or a painting) and a second drawing 3112 corresponding to a text (e.g., a handwritten text).

According to an embodiment, the electronic device 200 may use the second drawing 3112 along with the first drawing 3111 to generate an image. For example, the first drawing 311 may be a sketch of a cup. The second drawing 3112 may be a handwritten input of “Coffee”. The electronic device 200 may acquire at least one image (e.g., a first image 3113, a second image 3114, a third image 3115, and a fourth image 3116) (e.g., an image reflecting a coffee color) regarding a cup with coffee by using the first drawing 311 that may be the sketch of a cup, and the second drawing 3112 labeled “Coffee”.

According to an embodiment, the electronic device 200 may select an image style (a stele of an image to be generated) in response to a user input (e.g., a touch) on the first interface element 3151. The electronic device 200 may request an AI model (e.g., the second AI model 320 of FIG. 3) to generate an image in response to a user input of selecting the image generation button 3152.

According to an embodiment, the electronic device 200 may select (or set) a similarity between the first and second drawings 3111 and 3112 and the image to be generated in response to a user input on the second interface element 3153.

For example, when a touch occurs on the image generation button 3152 while the option corresponding to the second interface element 3153 in the first screen 3101 is unchecked (or disabled), the similarity may be set to a first value (first default value). For example, when a touch on the image generation button 3152 occurs while the option corresponding to the second interface element 3153 in the first screen 3101 is checked (or enabled) by the user, the similarity may be set to a second value (second default value) that may be lower than the first value.

According to an embodiment, the electronic device 200 may select (or set) the similarity according to the style selected via the first interface element 3151 and/or the user input on the second interface element 3153 (e.g., whether the option is checked).

For example, when a touch on the image generation button 3152 occurs while the option corresponding to the second interface element 3153 in the first screen 3101 is unchecked (or disabled), the similarity may be set to a third value according to the style selected via the first interface element 3151. The third value may be a value resulting from adjustment (e.g., increasing/decreasing) of the first value (first default value) according to the selected style. For example, when a touch on the image generation button 3152 occurs while the option corresponding to the second interface element 3153 in the first screen 3101 is checked (or enabled), the similarity may be set to a fourth value according to the style selected via the first interface element 3151. The fourth value may be a value resulting from adjustment (e.g., increasing, decreasing) of the second value (second default value) according to the selected style.

The electronic device 200 may display the second screen 3102 based on a user input on the first interface element 3151, a user input on the second interface element 3153, and a user input on the image generation button 3152.

The second screen 3102 may provide a text and a visual element 3120 indicating that the image is being generated as an animation effect. For example, the text indicating that the image is being generated may be at least one of phrases “Breathing warmth into the sketch . . . ”, “Adding speciality with an artistic sense . . . ”, or “Turning into a masterpiece . . . ”.

According to an embodiment, the text on the second screen 3102 indicating that the image is being generated may include image style information that is selected via the first interface element 3151 by the user. For example, when the selected image style is ‘watercolor’, the phrase “Breathing warmth into the sketch in a watercolor style . . . ” may be displayed. When the selected image style is a ‘pop-art style’, the phrase “Adding speciality to the pop-art style with an artistic sense . . . ” may be displayed. When the selected image style is a ‘3D cartoon’, the phrase “Turning into a great 3D cartoon artwork . . . ” may be displayed.

The electronic device 200 may acquire at least one image (e.g., a first image 3113, a second image 3114, a third image 3115, and a fourth image 3116) corresponding to the first and second drawings 3111 and 3112 inputted by the user. The electronic device 200 may display the acquired at least one image (e.g., the first image 3113, the second image 3114, the third image 3115, or the fourth image 3116).

The electronic device 200 may display the first image 3113 on the third screen 3103, and may display a portion of the second image 3114. The third screen 3103 may include the drawing area, and an indicator 3130 informing the number and positions of first to fourth acquired images 3113 to 3116 (e.g., a first page, a second page, a third page, a fourth page out of four (4) pages in total).

The electronic device 200 may sequentially display the fourth screen 3104, the fifth screen 3105, and the sixth screen 3106 in response to a predefined input (e.g., a swipe gesture) of the user.

FIG. 32 illustrates examples of user interfaces to explain a process of determining a style by the electronic device 200, according to an embodiment.

A drawing 3251 inputted by a user may be displayed on a first screen 3201.

The first screen 3201 may include a first interface element 3231 for selecting an image style (a style of an image to be generated), and an image generation button 3232. The first interface element 3231 may correspond to the first interface element 721 of FIG. 7B. The image generation button 3232 may correspond to the image generation button 741 of FIG. 7C.

The electronic device 200 may select an image style (style of an image to be generated) in response to a user input 3252 on the first interface element 3231 while the first screen 3201 is being displayed. The electronic device 200 may display a second screen 3202 in response to the user input 3252.

When the user input 3252 of selecting a main menu (e.g., a dialogue box) corresponding to the first interface element 3231 is received, the electronic device 200 may display a drop-down menu window 3220 including a list of sub-menus (e.g., a first sub-menu 3211, a second sub-menu 3213, a third sub-menu 3215, a fourth sub-menu 3217, and a fifth sub-menu 3219) indicating a plurality of styles on the second screen 3202. For example, the plurality of styles may include at least some of watercolor, illustration, sketch, pop-art, or 3-dimensional (3D) cartoon. For example, the first to fifth sub-menus 3211 to 3219 may include at least some of texts indicating predefined styles of images to be generated, or image objects (e.g., a first image object 3212, a second image object 3214, a third image object 3216, a fourth image object 3218, and a fifth image object 3210). For example, each of the first to fifth image objects 3212 to 3210 may be related with the drawing 3251 and the predefined style. For example, the first to fifth image objects 3212 to 3210 may be preview images informing how the drawing 3251 is generated in the predefined image style (or informing in which style the drawing is generated).

The electronic device 200 may generate a fourth input prompt including at least one of image data of a predefined first format (e.g., bmp data) and/or string data of a second format on the drawing 3251, in response to a user input on the first interface element 3231. The electronic device 200 may provide the fourth input prompt to the first AI model 310 and/or the second AI model 320 (e.g., an on-device AI model of the electronic device 200), thereby acquiring and displaying the first to fifth image objects 3212 to 3210 indicating the plurality of styles on the drawing 3251.

According to an embodiment, one style may be selected from the predefined styles in response to a user input on the drop-down menu window 3220. Thereafter, when a user input (e.g., a touch) on the image generation button 3232 occurs, the electronic device 200 may add an image object on the selected style to a first input prompt and/or a second input prompt. The electronic device 200 may provide the first input prompt and/or the second input prompt to which the image object is added to the first AI model 310 and/or the second AI model 320 (e.g., an AI model of an external server (e.g., the server 108 of FIG. 1)), thereby generating an image corresponding to the drawing 3251 based on the selected style.

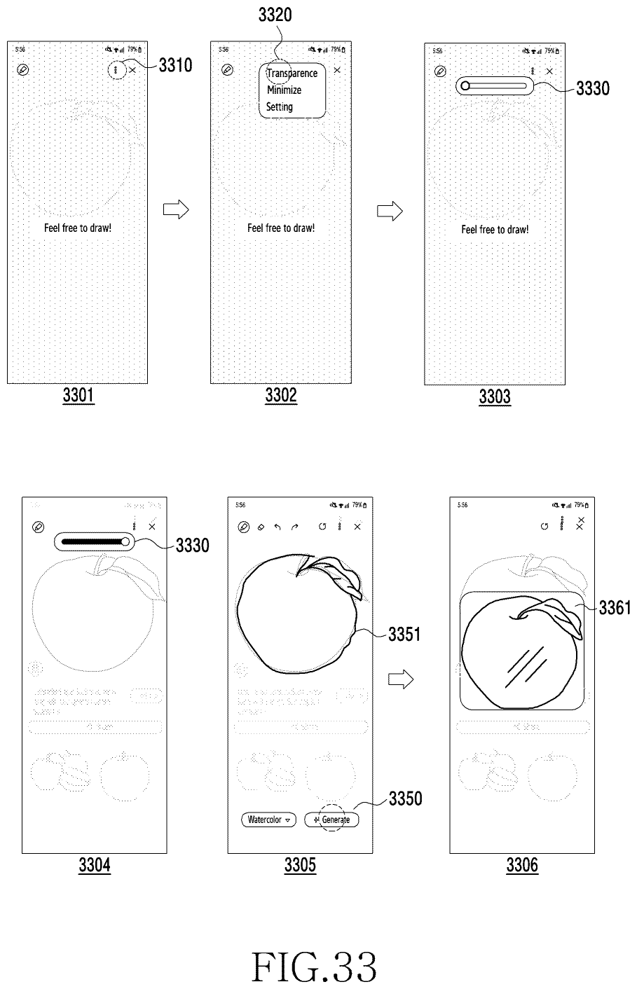

FIG. 33 illustrates examples of user interfaces to explain a process of determining a similarity based on transparency by the electronic device 200, according to an embodiment.

According to an embodiment, the electronic device 200 may perform an operation (e.g., operation 440 of FIG. 4) of determining a similarity between a user's drawing and an image to be generated, based on transparency. The similarity may correspond to a ratio of reflection of the drawing on the image to be generated (or a drawing reflection ratio).

According to an embodiment, the electronic device 200 may provide a reference image for assisting a user in inputting a drawing via a drawing area. The electronic device 200 may determine the drawing reflection ratio based on the transparency of the drawing area displaying the reference image.

Referring to FIG. 33, the electronic device 200 may display user interfaces such as a first screen 3301, a second screen 3302, a third screen 3303, a fourth screen 3304, a fifth screen 3305, and a sixth screen 3306 via the touch screen display 210. The first screen 3301, the second screen 3302, the third screen 3303, the fourth screen 3304, the fifth screen 3305, and the sixth screen 3306 may be execution screens of a first application (e.g., a note application).

A reference image that allows the user to draw along may be displayed in a drawing area of the first screen 3301 as a background image. A view more menu 3310 may be displayed in the drawing area of the first screen 3301.

In response to a user input of selecting the view more menu 3310 in the first screen 3301, the electronic device 200 may display the second screen 3302 including a pop-up window 3320 regarding sub-menus (e.g., transparency, minimization, setting).

The electronic device 200 may display the third screen 3303 including a transparency adjustment bar 3330 in response to a user input of selecting transparency from among the sub-menus of the pop-up window 3320 in the second screen 3302.

The electronic device 200 may set (or adjust) the transparency of the drawing area in response to a user input (e.g., a swipe gesture) on the transparency adjustment bar 3330.

The user may set the transparency of the drawing area to a desired value via the transparency adjustment bar 3330. The electronic device 200 may set the transparency of the drawing area in response to a user input (e.g., a swipe gesture) of adjusting the transparency via the transparency adjustment bar 3330, and may display the fourth screen 3304 reflecting the transparency.

When a user input on the drawing area occurs, the electronic device 200 may display the fifth screen 3305.

A drawing 3351 may be inputted on the fifth screen 3305 by a user input of drawing along the background image. When a user input of selecting the image generation button 3350 occurs after the drawing 3351 is inputted, the electronic device 200 may determine the drawing reflection ratio on the image to be generated differently depending on the transparency of the drawing area.

According to an embodiment, the electronic device 200 may transmit the user's drawing 3351 and the similarity corresponding to the transparency of the drawing area to an AI model (e.g., the second AI model 320 of FIG. 3). The electronic device 200 may transmit the reference image to the AI model as additional information to be additionally used for generating an image.

According to an embodiment, as the transparency of the drawing area is higher (more transparent), the drawing reflection ratio on the image to be generated may be lower and the reference image reflection ratio on the image may be higher. As the transparency of the drawing area is lower (more opaque), the drawing reflection ratio on the image to be generated may be higher and the reference image reflection ratio on the image may be lower.

For example, a first drawing reflection ratio when the transparency is set to 90% may have a lower value than a second drawing reflection ratio when the transparency is set to 30%. A first reference image reflection ratio when the transparency is set to 90% may have a higher value than a second reference image reflection ratio when the transparency is set to 30%.

The electronic device 200 may display a generated image 3361 that may be generated based on the drawing 3351, the transparency of the drawing area (or the similarity corresponding to the transparency) and the reference image via the sixth screen 3306.

According to an embodiment, the electronic device 200 may additionally provide a menu (not shown) for interlocking with a second application, which is a background application, by using the generated image 3361.

For example, the electronic device 200 may display, via the sixth screen 3306, a menu (e.g., menus for adding, transmitting) that interlocks with the second application (e.g., a social network service (SNS) application, a gallery application) that may be executed in the background to support the second application to use the generated image 3361. For example, when the second application is an SNS application, the generated image 3361 may be transformed into an emoji/emoticon and may be provided to the SNS application. The emoji/emoticon may be added to a previous conversation content of the SNS application or may be recommended or transmitted to an interlocutor of the previous conversation.

For example, when the second application is a gallery application, the generated image 3361 may be transformed into a sticker and may be provided to the gallery application. The sticker may be utilized via the gallery application. For example, the sticker may be added to a previous image (an image displayed in the gallery application before the first screen 3301 is displayed or drawing starts) of the gallery application.

According to an embodiment, the electronic device 200 may additionally provide an audio (e.g., a sound effect, a background music) related to the generated image 3361.

For example, the audio may be an audio that matches (or harmonizes with) the generated image 3361. The audio may an audio that reflects the style of the generated image 3361.

For example, the audio may include at least one of an audio acquired by the electronic device 200 (e.g., music replayed when the drawing is made, an audio collected through a microphone when the drawing is made), an audio stored in the electronic device 200, an audio generated by an AI model (e.g., the second AI model 320 of FIG. 3) that is trained to output an audio based on a second input prompt.

When displaying the generated image 3361 on the touch screen display 210, the electronic device 200 may additionally display an indicator (e.g., a speaker icon) indicating that the audio is also included, and may reproduce (or output) the audio in response to a user input of selecting the indicator. For example, the indicator may overlap a certain area of the generated image 3361.

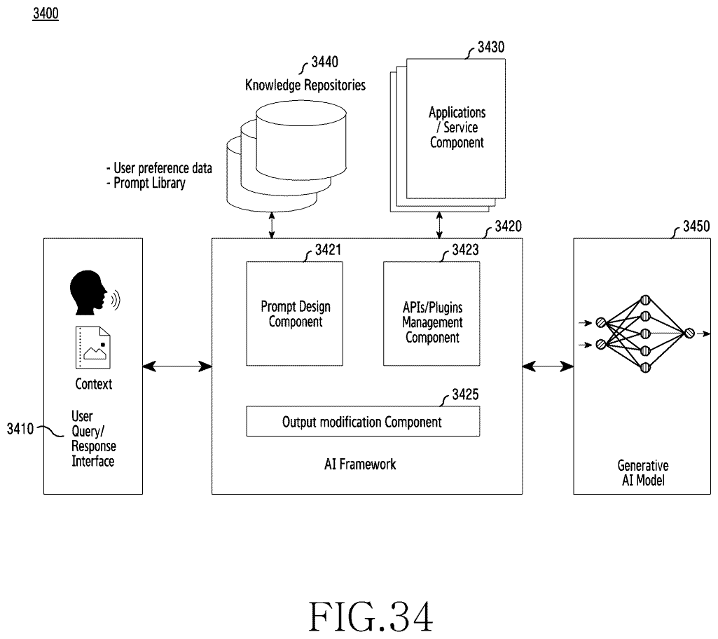

FIG. 34 is a view illustrating a system 3400 including a generative AI model, according to an embodiment.

Referring to FIG. 34, a user query/response interface 3410 may receive a user's input. The user's input may have such a form as a natural language, an image and/or a video. When the user's input is transmitted, context information may also be transmitted. The context information may include a variety of additional information at the time that the user's input is inputted. For example, there may be information of an application that the user currently uses, or position information of the user. In addition, the user input may have a mixed form of the natural language, image, sound, context information. In addition, the user input may have a non-natural language form of selecting a menu. The user query/response interface 3410 may output a result of the generative AI system to the user. The output may have a natural language form or a specific content form, or may be provided in the form of an action requested by the user. The user query interface may output a result of the generative AI system to the user. The output may have a natural language form or a specific content form, or may be provided in the form of an action requested by the user.

An AI framework 3420 may receive a user's input and may adjust and control respective components necessary for performing a user's intent based on a query of the user.

The user's input received from the user query/response interface 3410 may be transmitted to a prompt design component 3421. The prompt design component 3421 may use the user input in generating a prompt appropriate to inputting to a large language model (LLM) or a large multimodal model (LMM). The prompt design component 3421 may be an AI component that uses a machine learning algorithm or a neural network to develop better prompts with time. The prompt design component 3421 may access a knowledge component (e.g., knowledge repositories 3440) including user preference data, prompt library, and prompt examples, based on a user input, to generate prompts, and may deliver the generated prompts to the LLM or LMM.

An API/Plug-in management component 3423 may serve to communicate with external information if there is a request for additional information when transmitting the user input as an input to the generative model. The API/Plug-in management component 3423 may establish a channel to communicate with an AI interface via an API, and may enable access to various data sources (e.g., knowledge repositories 3440) via the established channel. In addition, when the API/Plug-in management component 3423 needs to perform an action that finally performs the user's input rather than an intermediate result at an application or a service, it may request the corresponding action from an application/service component 3430 via the API. Information acquired from the outside may be used at the prompt design component 3421 along with the user input to generate prompts, or may be delivered as an input to the generative model.

A refiner component (e.g., an output modification component 3425) may finely tune a result outputted from the generative AI model. For example, the refiner component may verify whether the content generated by the LLM and/or LMM is not irrelevant, biased, or harmful. In addition, the refiner component may determine the extent to which the result matches a result desired by the user, and, if additional processes are needed, the refine component may proceed with the corresponding process. The refiner component may constitute a hint to avoid an undesired output and may provide the hint to the user.

A generative AI model 3450 may refer to an AI neural network that typically relies on user input information and makes data of new forms. The generative AI model 3450 may include a model for generating images and/or a model for generating languages. Examples of image generating models may include a generative adversarial network (GAN), a variational auto encoder (VAE), and a diffusion-based generative model using a VAE and a transformer structure. The language generating model is a model that is trained to output most statistically appropriate output values based on input values, and for example, may be chat generative pre-trained transformer (CHAT-GPT) 3, CHAT-GPT 4. There are also LMMs that recognize various forms of data input such as texts, images, speech, or the like, and generate new data correspondingly.

According to an embodiment, the electronic device 101 of FIG. 1 and/or the electronic device 200 of FIG. 2 may be configured to include at least some of the user query/response interface 3410, the AI framework 3420, the application/service component 3430, the knowledge repositories 3440, or the generative AI model 3450 of FIG. 34. According to an embodiment, at least some of the user query/response interface 3410, the AI framework 3420, the application/service component 3430, the knowledge repositories 3440, or the generative AI model 3450 of FIG. 33 may be included on another electronic device (e.g., an electronic device of another user (e.g., the electronic devices 102 and 104 of FIG. 1) and/or server (e.g., the server 108 of FIG. 1)).

In the present disclosure, the image providing methods, according to various embodiments, have been described with reference to FIGS. 4, 6, 8, 9, 12, 14, 16, 19, and 27. The operations illustrated in the drawings may be performed sequentially, but may not necessarily be performed sequentially. For example, the order of the operations may be changed, and at least two (2) operations may be performed in parallel. In some embodiments, some of the illustrated operations may be omitted, some operations may be integrated, the order of some operations may be changed, or other operations may be added. At least some of the operations of the image providing methods, according to the various embodiments, described with reference to FIGS. 4, 6, 8, 9, 12, 14, 16, 19, and 27 may correspond to one another. At least some of the above operations may be performed in combination with one another.

In various embodiments of the present disclosure, the interface elements, visual elements, graphical elements, menus, pop-up windows, menu windows, icons, dialog boxes, or the like illustrated as components of a user interface or a screen are merely examples, and the type, number, interaction, placement, or layout of the components may be modified, changed, or applied in various ways. Screens, according to various embodiments, of the present disclosure may be various types of screens (e.g., home screen, application execution screen, browser screen, web screen, full screen, partial screen, camera preview screen, XR environment screen) that may be displayed on an electronic device or may be displayed to include contents (e.g., images, videos, documents).

According to an embodiment, an electronic device (e.g., the electronic device 200) may include a touch screen display (e.g., the touch screen display 210), at least one processor (e.g., the processor 220), and memory (e.g., the memory 230) configured to store instructions. When executed by the at least one processor, the instructions may cause the electronic device to: receive a drawing in response to a first user input via the touch screen display, receive a second user input for generating an image via the touch screen display, acquire description information on the drawing by using the drawing, based on the second user input, determine a similarity between the drawing and an image to be generated, acquire an image generated based on at least a portion of the description information and the similarity, and display the image via the touch screen display.

According to an embodiment, the similarity may be determined by a defined default value.

According to an embodiment, a first interface element may be displayed on the touch screen display to select a style of the image to be generated from a plurality of styles. The similarity may be determined based on a style that is selected by a user input on the first interface element.

According to an embodiment, a first interface element may be displayed on the touch screen display to select a style of the image to be generated from a plurality of styles. A length of the description information may be determined based on a style that is selected by a user input on the first interface element.

According to an embodiment, a second interface element may be displayed on the touch screen display to select the similarity. The similarity may be determined based on a user input on the second interface element.

According to an embodiment, the similarity may be determined based on a skill level of the drawing. When the skill level is a low level, the similarity may have a first value. When the skill level is a high level, the similarity may have a second value that may be higher than the first value.

According to an embodiment, the similarity may be determined based on transparency of a drawing area for receiving the drawing.

According to an embodiment, when executed by the at least one processor, the instructions may cause the electronic device to: provide a first input prompt including the drawing to a first AI model in response to the second user input, thereby acquiring the description information, and provide a second input prompt including at least a portion of the description information and the similarity to a second AI model, thereby acquiring the image.

According to an embodiment, the second input prompt may further include at least some of the drawing, image style information, a reference text that may be inputted by a user, a reference image, form factor information of the electronic device, or form factor information of an external electronic device that may be connected with the electronic device via short-range wireless communication.

According to an embodiment, when executed by the at least one processor, the instructions may cause the electronic device to: display a user interface including at least one keyword related to the description information, receive a user input on the at least one keyword via the user interface, and edit the description information based on the user input. The image may be acquired based on at least a portion of the edited description information.

According to an embodiment, when executed by the at least one processor, the instructions may cause the electronic device to display a user interface for receiving the drawing on the touch screen display in response to a triggering event occurring. The triggering event may include at least one of a first event in which a hovering input of an electronic pen is detected, a second event in which a user input of selecting a predefined visual element within an edge area of the touch screen display is detected, or a third event in which a user input of selecting a predefined visual element within an application execution screen is detected.

According to an embodiment, a method of providing an image by an electronic device (e.g., the electronic device 200) may include: receiving a drawing in response to a first user input via a user interface displayed on a touch screen display (e.g., the touch screen display 210) of the electronic device, receiving a second user input for generating an image via the user interface, acquiring description information on the drawing by using the drawing, based on the second user input, determining a similarity between the drawing and an image to be generated, acquiring an image generated based on at least a portion of the description information and the similarity, and displaying the image via the touch screen display.

According to an embodiment, the user interface may include a first interface element for selecting a style of the image to be generated from a plurality of styles. The similarity may be determined based on a style that is selected by a user input on the first interface element.

According to an embodiment, the user interface may include a first interface element for selecting a style of the image to be generated from a plurality of styles. A length of the description information may be determined based on a style that is selected by a user input on the first interface element.

According to an embodiment, the user interface may include a second interface element for selecting the similarity. The similarity may be determined based on a user input on the second interface element.

According to an embodiment, the similarity may be determined based on a skill level of the drawing. When the skill level is a low level, the similarity may have a first value. When the skill level is a high level, the similarity may have a second value that may be higher than the first value.

According to an embodiment, the similarity may be determined based on transparency of a drawing area for receiving the drawing.

According to an embodiment, acquiring the description information may be performed by providing a first input prompt including the drawing to a first AI model. Acquiring the image may be performed by providing a second input prompt including at least a portion of the description information and the similarity to a second AI model.

According to an embodiment, the second input prompt may further include at least some of the drawing, image style information, a reference text that may be inputted by a user, a reference image, form factor information of the electronic device, or form factor information of an external electronic device that may be connected with the electronic device via short-range wireless communication.

According to an embodiment, a computer readable non-transitory recording medium may have a program recorded thereon to execute a method, the method including: receiving a drawing in response to a first user input via a user interface displayed on a touch screen display (e.g., the touch screen display 210) of an electronic device (e.g., the electronic device 200), receiving a second user input for generating an image via the user interface, acquiring description information on the drawing by using the drawing, based on the second user input, determining a similarity between the drawing and an image to be generated, acquiring an image generated based on at least a portion of the description information and the similarity, and displaying the image via the touch screen display.

Various embodiments of the present disclosure may support a user to represent a desired direction through a simple drawing without having to acquaint with a complex prompt structure or to perform a cumbersome text input.

Various embodiments of the present disclosure may improve user convenience while implementing an image accurately reflecting user's intent.

The effects achieved by the present disclosure are not limited to those mentioned above, and other effects that are not mentioned above may be clearly understood to those skilled in the art based on the description provided above.

The electronic device, according to an embodiment of the present disclosure, may be one of various types of electronic devices. The electronic device may include, for example, a portable communication device (e.g., a smart phone), a computer device, a portable multimedia device, a portable medical device, a camera, a wearable device, or a home appliance. According to an embodiment of the present disclosure, the electronic device is not limited to those described above.

It should be appreciated that various embodiments of the present disclosure and the terms used therein are not intended to limit the technological features set forth herein to particular embodiments and include various changes, equivalents, or alternatives for a corresponding embodiment. With regard to the description of the drawings, similar reference numerals may be used to refer to similar or related elements. It is to be understood that a singular form of a noun corresponding to an item may include one or more of the items, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of the items enumerated together in a corresponding one of the phrases, or all possible combinations thereof. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the present disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method, according to various embodiments of the present disclosure, may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two (2) user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in other components. According to an embodiment, one or more of the above-described components or operations may be omitted, or one or more other components or operations may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a touch screen display;
one or more processors comprising processing circuitry; and
memory storing instructions,
wherein the instructions, when executed by the one or more processors individually or collectively, cause the electronic device to:
receive, via the touch screen display, a drawing based on a first user input;
receive, via the touch screen display, a second user input for generating an image;
acquire description information of the drawing, based on the second user input;
determine a similarity between the drawing and the image to be generated;
cause a new image to be generated based on at least a portion of the description information and the similarity; and
display, via the touch screen display, the new image.

2. The electronic device of claim 1, wherein the instructions, when executed by the one or more processors individually or collectively, cause the electronic device to:
determine the similarity between the drawing and the image to be generated based on a default value.

3. The electronic device of claim 1, wherein the instructions, when executed by the one or more processors individually or collectively, cause the electronic device to:
display, via the touch screen display, a first interface element configured to obtain a selection of a style of the image to be generated from a plurality of styles; and
determine the similarity between the drawing and the image to be generated based on the style of the image to be generated selected by a third user input on the first interface element.

4. The electronic device of claim 1, wherein the instructions, when executed by the one or more processors individually or collectively, cause the electronic device to:
display, via the touch screen display, a first interface element configured to obtain a selection of a style of the image to be generated from a plurality of styles; and
determine a length of the description information based on the style of the image to be generated selected by a third user input on the first interface element.

5. The electronic device of claim 1, wherein the instructions, when executed by the one or more processors individually or collectively, cause the electronic device to:
display, via the touch screen display, a first interface element configured to obtain a selection of the similarity; and
determine the similarity between the drawing and the image to be generated based on a third user input on the first interface element.

6. The electronic device of claim 1, wherein the instructions, when executed by the one or more processors individually or collectively, cause the electronic device to:
determine a skill level of the drawing comprising at least one of a first skill level or a second skill level, the second skill level being greater than the first skill level;
determine the similarity between the drawing and the image to be generated to have a first value, based on the skill level being the first skill level; and
determine the similarity between the drawing and the image to be generated to have a second value, based on the skill level being the second skill level, the second value being greater than the first value.

7. The electronic device of claim 1, wherein the instructions, when executed by the one or more processors individually or collectively, cause the electronic device to:
determine the similarity between the drawing and the image to be generated based on a transparency of a drawing area of the drawing.

8. The electronic device of claim 1, wherein the instructions, when executed by the one or more processors individually or collectively, cause the electronic device to:
acquire, from a first artificial intelligence (AI) model, the description information of the drawing by providing, to the first AI model, the drawing; and
acquire, from a second AI model, the image to be generated by providing, to the second AI model, the portion of the description information and the similarity.

9. The electronic device of claim 8, wherein the instructions, when executed by the one or more processors individually or collectively, cause the electronic device to:
acquire, from the second AI model, the image to be generated by further providing, to the second AI model, at least one of a portion of the drawing, image style information, a reference text inputted by a user, a reference image, form factor information of the electronic device, or form factor information of an external electronic device coupled with the electronic device via short-range wireless communication.

10. The electronic device of claim 1, wherein the instructions, when executed by the one or more processors individually or collectively, cause the electronic device to:
display, via the touch screen display, a user interface comprising at least one keyword related to the description information;
receive, via the user interface, a third user input on the at least one keyword via the user interface;
modify the description information based on the third user input; and
cause the new image to be generated based on at least a portion of the modified description information and the similarity.

11. The electronic device of claim 1, wherein the instructions, when executed by the one or more processors individually or collectively, cause the electronic device to:
display, via the touch screen display, a user interface configured to receive the drawing based on an occurrence of a triggering event,
wherein the triggering event comprises at least one of detection of a hovering input of an electronic pen, selection of a predefined visual element within an edge area of the touch screen display, or selection of a predefined visual element within an application execution screen.

12. A method of providing an image by an electronic device, the method comprising:
receiving, via a user interface displayed on a touch screen display of the electronic device, a drawing based on a first user input;
receiving, via the user interface, a second user input for generating the image;
acquiring description information of the drawing, based on the second user input;
determining a similarity between the drawing and the image to be generated;
causing a new image to be generated based on at least a portion of the description information and the similarity; and
displaying, via the touch screen display, the new image.

13. The method of claim 12, wherein the determining of the similarity between the drawing and the image to be generated comprises:
displaying, via the user interface, a first interface element for obtaining a selection of a style of the image to be generated from a plurality of styles; and
determining the similarity between the drawing and the image to be generated based on the style of the image to be generated selected by a third user input on the first interface element.

14. The method of claim 12, wherein the acquiring of the description information of the drawing comprises:
displaying, via the user interface, a first interface element for obtaining a selection of a style of the image to be generated from a plurality of styles; and
determining a length of the description information based on the style of the image to be generated selected by a third user input on the first interface element.

15. The method of claim 12, wherein the determining of the similarity between the drawing and the image to be generated comprises:
displaying, via the user interface, a first interface element for obtaining a selection of the similarity; and
determining the similarity between the drawing and the image to be generated based on a third user input on the first interface element.

16. The method of claim 12, wherein the determining of the similarity between the drawing and the image to be generated comprises:
determine a skill level of the drawing comprising at least one of a first skill level or a second skill level, the second skill level being greater than the first skill level; and
determine the similarity between the drawing and the image to be generated based on the skill level of the drawing,
wherein the similarity is determined to have a first value based on the skill level of the drawing being the first skill level,
wherein the similarity is determined to have a second value based on the skill level of the drawing being the second skill level, and
wherein the second value is greater than the first value.

17. The method of claim 12, wherein the determining of the similarity between the drawing and the image to be generated comprises:
determining the similarity between the drawing and the image to be generated based on a transparency of a drawing area of the drawing.

18. The method of claim 12, wherein the acquiring of the description information comprises acquiring, from a first artificial intelligence (AI) model, the description information of the drawing by providing, to the first AI model, the drawing, and
wherein causing the new image to be generated comprises acquiring, from a second AI model, the new image to be generated by providing, to the second AI model, the portion of the description information and the similarity.

19. The method of claim 18, wherein causing the new image to be generated further comprises acquiring, from the second AI model, the new image to be generated by further providing, to the second AI model, at least one of a portion of the drawing, image style information, a reference text inputted by a user, a reference image, form factor information of the electronic device, or form factor information of an external electronic device coupled with the electronic device via short-range wireless communication.

20. A non-transitory computer readable storage medium storing a computer-executable program for providing an image that, when executed by at least one processor of an electronic device, cause the electronic device to:
receive, via a user interface displayed on a touch screen display of the electronic device, a drawing based on a first user input;
receive, via the user interface, a second user input for generating the image;
acquire description information of the drawing, based on the second user input;
determine a similarity between the drawing and the image to be generated;
cause a new image to be generated based on at least a portion of the description information and the similarity; and
display, via the touch screen display, the new image.
